(19) United States
(12) Patent Application Publication
(10) Pub. No.: US 2025/0031727 A1
(43) Pub. Date: Jan. 30, 2025

(54) FEED COMPOSITION AND USES THEREOF

(71) Applicant: GIVAUDAN SA, VERNIER (CH)

(72) Inventors: Anne PASSEMARD, Avignon (FR); Jorge PROENCA DIAS, São Brás de Alportel (PT)

(21) Appl. No.: 18/708,951

(22) PCT Filed: Nov. 2, 2022
(86) PCT No.: PCT/EP2022/080497

§ 371 Date: May 9, 2024

(30) Foreign Application Priority Data
Nov. 12, 2021 (GB) 2116351.4

(51) Int. Cl. A23K 20/163; A23K 50/80

(52) U.S. Cl. CPC A23K 20/163; A23K 50/80

(57) ABSTRACT

The present invention relates to a feed composition comprising unbranched beta glucans and at least one more animal feed supplement and uses thereof. The unbranched beta glucans are preferably derived from oat. The feed composition is of particular use in the increase in growth yield of aquaculture animals.

### FIELD OF THE INVENTION

The present invention relates to a food component comprising unbranched beta-glucans derived from oat bran and its uses in compositions adequate for animal feeding, particularly for aquaculture.

### BACKGROUND OF THE INVENTION

Animals are exposed to many stresses during their lives that have been shown to affect health, growth, mortality, immune system health, and overall well-being of the animal. This is a known and growing problem in the high intensity breeding systems of nowadays. Of all the current animal breeding systems, fish farming or aquaculture is one of the fastest growing systems in the world. Due to this, several problems have become apparent such as worsening breeding environment, pollution of waters due to high density farming and spillage of feeds into the environmental waters, fish diseases due to external factors such as water pollution wish inhibits fish growth, changed parameters of competitiveness of the fish due to the growth conditions leading to problems in fish abilities and smaller fish than their wild type counterparts.

Therefore, food components and feed compositions that promote a better feeding efficiency are required to reduce the amount of feeding spillage into the environmental waters and by association reduce the amount of contamination waters. In addition, said feeds must also promote a healthier fish development and growth by increasing their immune response and reduce their levels of inflammation due to stress and over feeding.

An example of a component used to stimulate immune system activity is beta glucan. Beta glucans are polysaccharides connected by beta glycosidic linkages that can be found in various organisms, such as yeast, mushrooms, fungi, cereal grains, and others. Beta-glucan is used as a dietary supplement and various beneficial effects thereof are the subject of several clinical trials. Beta glucan products are currently derived primarily from yeast, where they are extracted from the yeast cell wall using various processes.

Besides their origin, beta glucans can also be distinguished by their structure, which is diverse and complex and provides with different structural properties. The beta glucans that occur in yeast, fungi and bacteria are structurally different from those in grains such as oats and barley, and, like cellulose which also is a beta glucan, they are not readily soluble in water and lack functional value in their natural state. Variations in branching structure, molecular weight, source organism, and method of production and extraction can all affect the efficacy and suitability of different beta glucan products which leads to differences in the effect beta glucans have in animals which ingest them.

Therefore, there is a need for food components and feed compositions which promote feed utilization by animals, improve immune response by animals and promote resistance to inflammatory processes, preferably using beta glucans.

### BRIEF DESCRIPTION OF THE INVENTION

The present invention authors discovered that the use of unbranched beta glucans formed by β-D-glucopyranosyl monomers connected by either β-1,3 glucosidic bonds and/or β-1,4 glucosidic bonds in feed components leads to an increase in feed utilization, promotes humoral response and protects the intestinal mucosa in an animal.

Therefore, a first aspect of the present invention relates to a feed composition comprising at least 0.05% by weight (w %) of unbranched beta glucan and one or more animal feed components, wherein the unbranched beta-glucan is formed by β-D-glucopyranosyl monomers connected by either β-1,3 glucosidic bonds and/or β-1,4 glucosidic bonds.

Another aspect relates to a second process for obtaining a feed composition according to the invention comprising:
i) Providing a composition comprising at least 0.05% by weight (wt %) of an unbranched beta glucan at least 0.2% wt % derived from the food complement according to the invention;
ii) Mixing the unbranched beta glucan and the animal feed component as to obtain a mixture with a content of unbranched glucan of at least 0.05 wt %, thereby obtaining the feed composition.

Another aspect relates to a feed composition obtained by the second process according to the invention.

One more aspect relates to a method for rearing aquaculture animals which comprises feeding the aquaculture animals with a feed composition according to the invention or with a feed composition according to the invention or with a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

Another aspect of the present invention relates to a method to increase the weight yield of an animal, to increase feed utilization by an animal, to improve humoral response in an animal and/or to increase the protective intestinal mucosa in an animal comprising the step of providing the animal with the feed composition according to the invention or with the feed composition according to the invention or with a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

Another aspect of the present invention relates to a method to increase the weight yield of an animal, to increase feed utilization by an animal, to improve humoral response in an animal and/or to increase the protective intestinal mucosa in an animal comprising the step of providing the animal with
a) a feed composition comprising at least 0.05% wt % of unbranched beta glucan and one or more animal feed components, wherein the unbranched beta glucan is formed by β-D-glucopyranosyl monomers connected by either β-1,3 glucosidic bonds and/or β-1,4 glucosidic bonds,
or with b) a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

Another aspect of the present invention relates to A feed composition for use in a method to increase the weight yield of an animal, for use in a method to increase feed utilization by an animal, for use in a method to improve humoral response in an animal and/or for use in a method to increase the protective intestinal mucosa in an animal in an animal, wherein the feed composition comprises at least 0.05% wt % of unbranched beta glucan and one or more animal feed components, wherein the unbranched beta glucan is formed by β-D-glucopyranosyl monomers connected by either β-1,3 glucosidic bonds and/or β-1,4 glucosidic bonds.

Another aspect of the present invention relates to a food supplement comprising at least 5% by weight (wt %), at least 10 wt %, preferably at least 20 wt %, more preferably at least 23 wt % of an unbranched beta glucan for use in a method to increase the weight yield of an animal, for use in a method to increase feed utilization by an animal, for use in a method to improve humoral response in an animal and/or for use in a method to increase the protective intestinal mucosa in an animal in an animal, wherein the food supplement unbranched beta glucan is formed by β-D-glucopyranosyl monomers connected by either β-1,3 glucosidic bonds and/or β-1,4 glucosidic bonds, and wherein the food supplement is suitable for animal feed.

In certain embodiments, the unbranched beta-glucan is derived from oat bran

Another aspect of the present invention relates to the feed composition according to the invention or the feed composition according to the invention or a food supplement comprising at least 5% by weight (wt %), at least 10 wt %, preferably at least 20 wt %, more preferably at least 23 wt % of an unbranched beta glucan for use in a method to improve humoral response in an animal, wherein the food supplement unbranched beta glucan is formed by β-D-glucopyranosyl monomers connected by either β-1,3 glucosidic bonds and/or β-1,4 glucosidic bonds, and wherein the food supplement is suitable for animal feed.

Another aspect of the present invention relates to the feed composition according to the invention or the feed composition according to the invention or a food supplement comprising at least 5% by weight (wt %), at least 10 wt %, preferably at least 20 wt %, more preferably at least 23 wt % of an unbranched beta glucan for use in a method to increase the protective intestinal mucosa in an animal, wherein the food supplement unbranched beta glucan is formed by β-D-glucopyranosyl monomers connected by either β-1,3 glucosidic bonds and/or β-1,4 glucosidic bonds, and wherein the food supplement is suitable for animal feed.

### DESCRIPTION OF THE FIGURES

FIG. 1: Water parameters during the 65 days of the experimental trial.

FIG. 2: Changes on body weight (BW) during the trial. Bars are means±standard deviation (n=3). Different superscripts, denote a statistical difference (P<0.05).

FIG. 3: Changes on feed utilisation criteria at the end of the trial (day 65). Bars are means±standard deviation (n=3). Different superscripts, denote a statistical difference (P<0.05).

FIG. 4: Intestinal histomorphometry criteria of fish after 65 days of feeding. Bars are means±standard deviation (n=6). Bars with different superscripts denote a statistical difference (P<0.05).

FIG. 5: Plasma immune criteria pre and post-inflammatory challenge. Bars are means±standard deviation (n=6). Bars with different superscripts denote a statistical difference (P<0.05).

### DETAILED DESCRIPTION OF THE INVENTION

The authors of the present invention have found that the use of unbranched beta glucans formed by β-D-glucopyranosyl monomers connected by either β-1,3 glucosidic bonds and/or β-1,4 glucosidic bonds in feed components leads to an increase in feed utilization, promotes humoral response and protects the intestinal mucosa in animals and, more in particular, in animals which are grown in aquaculture.

Therefore, a first aspect of the present invention relates to a feed composition, from here onwards the feed composition of the invention, comprising at least 0.05% by weight (wt %) of unbranched beta glucan and one or more animal feed components, wherein the unbranched beta-glucan is formed by β-D-glucopyranosyl monomers connected by either β-1,3 glucosidic bonds and/or β-1,4 glucosidic bonds.

The term “feed composition” or “feed” as used herein refers to the total feed composition of an animal diet or to a part thereof, including e.g. supplemental feed, premixes and other feed compositions. The feed may comprise different active ingredients. As used herein the feed composition of the present invention is not suitable for human consumption. In present context the feed composition comprises unbranched beta glucans and one or more animal feed components.

The terms “beta glucan” and “β-glucan” are used interchangeably in the present description and refer to a group of β-D-glucose polysaccharides naturally occurring in the cell walls of cereals, bacteria, and fungi, with significantly differing physicochemical properties dependent on the source from which they are obtained. Glucans are arranged in six-sided D-glucose rings connected linearly at varying carbon positions depending on the source, although most commonly β-glucans include a 1-3 glycosidic link, a covalent bond that joins a carbohydrate (sugar) molecule to another group, which may or may not be another carbohydrate, in their backbone. Although technically β-glucans are chains of D-glucose polysaccharides linked by β-type glycosidic bonds, by convention not all β-D-glucose polysaccharides are categorized as β-glucans. Cellulose is not conventionally considered a β-glucan, as it is insoluble and does not exhibit the same physicochemical properties as other cereal or yeast β-glucans. The most common forms of β-glucans are those comprising D-glucose units with β-1,3 links. Yeast and fungal β-glucans contain 1-6 side branches, while cereal β-glucans contain both β-1,3 and β-1,4 backbone bonds. Some β-glucan molecules have branching glucose side-chains attached to other positions on the main D-glucose chain, which branch off the β-glucan backbone. The beta glucans of the present invention are “unbranched beta glucans”, i.e., they do not possess glucose side chains units.

The unbranched beta glucans of the feed composition of the invention is formed by β-D-glucopyranosyl monomers connected by either β-1,3 glucosidic bonds and/or by

β-1,4 glucosidic bonds. The expression “β-D-glucopyranosyl monomer” refers to an element with the structure according to the formula (1):

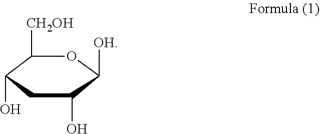

β-D-glucopyranosyl monomers can be connected by β-1,3 glucosidic bonds according to formula (2):

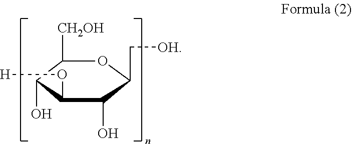

β-D-glucopyranosyl monomers can be connected by β-1,4 glucosidic bonds according to formula (3):

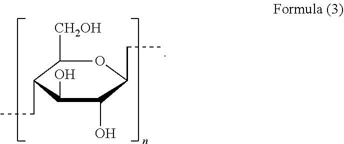

In a preferred embodiment of the feed composition of the invention the unbranched beta glucans defined by the structure according to formula (4):

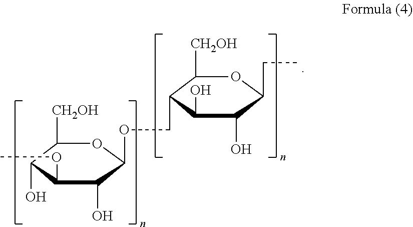

In a preferred embodiment the feed composition comprises from about 0.05% wt % to about 0.2% wt %, from 0.06% wt % to 0.18% wt %, from 0.08% wt % to 0.16% wt %, from 0.10% wt % to 0.14% wt %, from 0.10% wt % to 0.12% wt %, preferably from about 0.06% wt % to about 0.012% wt % of unbranched beta glucan. In another preferred embodiment of the feed composition of the invention the concentration of unbranched beta glucan is between 400 mg/Kg and 1400 mg/Kg, preferably between 600 mg/Kg and 1200 mg/Kg.

As previously mentioned, beta glucans structure will vary depending on the source from which they are obtained, i.e., yeast, bacteria, fungi or cereals. In a preferred embodiment of the feed composition of the invention the unbranched beta glucan is derived from cereals. The term “derived” as used herein refers to the fact that the unbranched beta glucans are obtained from a source which is rich in beta glucans, or can be concentrated to provide a rich source of unbranched beta glucans. The term “cereals” as used herein encompasses oat, barley and rye. In a preferred embodiment of the feed composition of the invention the unbranched beta glucan derives from oat. The term “oat” as used herein refers to the whole grain obtained, after removing the husk, from the plant species Avena sativa. The whole grain is composed of three edible parts, the bran, the germ and the endosperm, which are found inside the inedible husk.

In a preferred embodiment of the feed composition of the invention the unbranched beta glucan derives from oat bran. The term “oat bran” as used herein refers to oat bran that has been isolated from whole oat grains. Isolated oat bran comprises a high concentration of fiber, fatty acids, starch, protein, vitamins, and minerals. In particular, oat bran is rich in beta glucan soluble fiber. In a preferred embodiment the oat bran is enriched in unbranched beta glucans. In another preferred embodiment the feed composition of the invention comprises a minimal oat bran content in the composition of 0.2% wt %. In another preferred embodiment the oat bran comprises at least 5% wt %, preferably at least 10% wt %, more preferably at least 20% wt %, yet more preferably at least 23% wt % of unbranched beta glucan. Methods to determine the concentration of unbranched beta glucans in cereals, specifically in oat and oat bran is commonly known to the skilled person in the art and standardize methods can be easily used, namely the method provided by the Association of Official Agricultural Chemists (AOAC) Official Method 995.16 β-D-Glucan in Barley and Oats Streamlined Enzymatic Method First Action 1995 available at www.AOAC.org.

Depending on the source and method of extraction β-glucans can vary with respect to molecular weight, solubility, and branching structure, causing diverse physiological effects in animals.

The term “molecular weight” as used herein refers to the sum of the atomic masses of all atoms in a molecule, based on a scale in which the atomic masses of hydrogen, carbon, nitrogen, and oxygen are 1, 12, 14, and 16, respectively. Despite this, beta glucans are simple pure compounds, but polymers and therefore are not composed of identical molecules, with the lengths of different beta glucan molecules possibly varying by thousands of monomer units. Therefore, the molecular weight of beta glucans, and polymers in general, are given as averages. Two experimentally determined values are common: the number average molecular weight, which is calculated from the mole fraction distribution of different sized molecules in a sample, and the weight average molecular weight, which is calculated from the weight fraction distribution of different sized molecules. In a preferred embodiment of the feed of the composition of the invention the weight-average molecular weight of the unbranched beta glucan is at least 800 Kda, at least 1000 kDa, at least 1200 kDa, at least 1500 kDa, at least 1600 kDa, at least 1700 kDa, at least 1800 kDa, at least 1900 kDa, at least 2000 kDa, at least 2100 kDa, at least 2200 kDa. To determine the molecular weight of beta glucans in a sample several known techniques are available, including, without limitation, HPLC, high performance liquid chromatography; MALLS, multiangle laser light scattering method; RI, refractive index detector; SEC, size-exclusion chromatography; DRI, differential refractive index; HPSEC, high-performance size exclusion chromatography; SE-HPLC, size-exclusion high-performance liquid chromatography; LLS, laser light scattering; Pd, polydispersity index; VS, viscosity detector; RALLS, right-angle laser light scattering detector; DV, differential viscometer; DP, differential pressure (Du et al., Int J Mol Sci. 2019 August; 20(16): 4032).

The term “solubility” as used herein refers to the amount of β-glucan in an extract of the feed composition and is expressed as the percentage of the total β-glucan content in the feed composition that is found in the extract. Methods to determine the solubility of beta glucans can be found in the literature (Chaplin, M. F., Proceedings of the Nutrition Society 2003, 62, 223-227; Robertson et al., J. Sci. Food Agric., 1981, 32, 819-825) and the skilled person in the art would have the knowledge to put in practice said methods. In a preferred embodiment of the feed composition of the invention the solubility of the unbranched beta glucan is of at least 70%, at least 75%, at least 80%, at least 85%, at least 86%, at least 87%, at least 88%, at least 89%, preferably at least 90%. In certain embodiments, the minimal oat bran content in the composition is of 0.2 wt %.

As previously mentioned, beta glucans can be derived from several sources, namely and without limitation, yeast, bacteria, fungi and cereals such as barley, rye and oat. As previously states also, the structure of the beta glucan will depend on the source from where it derives. In preferred embodiment of the feed composition of the invention, the composition is substantially devoid of yeast-derived beta-glucans, of fungi-derived beta-glucans and/or of barley-derived beta glucans. The term “devoid” as used herein refers to the fact that the feed composition of the invention has less than 5.00% wt %, less than 5.00%, less than 1.00%, more preferably less than 0.80%, less than 0.60%, less than 0.40%, less than 0.20%, even more preferably less than 0.1%, less than 0.05%, less than 0.01% of beta glucans which are yeast-derived beta-glucans, fungi-derived beta-glucans and/or of barley-derived beta glucans.

In another preferred embodiment of the feed composition of the invention, the composition is substantially devoid of beta-glucans containing β-(1-6)-linked side chains. In a preferred embodiment the composition has less than 5.00% wt %, less than 5.00%, less than 1.00%, more preferably less than 0.80%, less than 0.60%, less than 0.40%, less than 0.20%, even more preferably less than 0.1%, less than 0.05%, less than 0.01% of beta-glucans containing β-(1-6)-linked side chains. In a preferred embodiment the beta glucans containing β-(1-6)-linked side chains are defined by the structure according to formula (5):

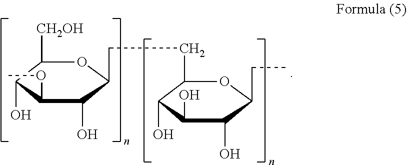

The feed composition of the invention contains in addition to the unbranched beta glucans one or more animal feed component.

The term “feed component” as used herein refers to any product suitable for feeding to animals. “Animal” refers to any non-human animal, in particular non-human mammals. In some embodiments, the term “animal” may refer to aquatic animals. In one embodiment, the term “animal” may refer to fish, preferably trout. In a preferred embodiment of the feed composition of the invention, the feed component comprises two or more premix components. As used herein the term “premix” refers to two or more components which are blended or mixed together as a feed component before being added to the feed composition of the invention.

In a preferred embodiment of the feed composition of the invention the animal feed component is selected from a group consisting of a protein source, a lipid source, a vitamin, an essential mineral, an antioxidant, an inorganic phosphate source, an essential amino acid, a source of phospholipids and any combination thereof.

The term “protein source” as used herein refers to the sum of all protein component elements that an animal obtains from a feed. In a preferred embodiment of the feed composition of the invention the animal feed component protein source is an animal and/or vegetal protein source. Examples of protein source which are suitable for animal feed composition are, without limitation, fishmeal, meat meal, bone meal, porcine blood meal, poultry meal, soy protein concentrate, wheat gluten, corn gluten meal, soy bean meal, sunflower meal, wheat, cottonseed cake, groundnut cake, pigeon peas, cowpeas and chickpeas. In a preferred embodiment of the feed composition of the invention the animal feed component protein source is selected from a group consisting of fishmeal, porcine blood meal, poultry meal, soy protein concentrate, wheat gluten, corn gluten meal, soy bean meal, sunflower meal, wheat and any combination thereof.

The term “lipid source” as used herein refers to the sum of all lipid component elements that an animal obtains from a feed. In a preferred embodiment of the feed composition of the invention the animal feed component lipid source is an animal and/or vegetal lipid source. Lipids are a group of structurally diverse, water-insoluble, organic-solvent-soluble compounds. Lipids have hydrocarbon chains or rings as a major part of their chemical structure, with the primary types of hydrocarbons being fatty acids (FA) and steroids. Fatty acids are linear, aliphatic monocarboxylic acids [R—(CH2) nCOO—], and almost always have an even number of carbons. Unsaturated FA may contain one or more cis double bonds. No conjugated double bond lipids are found in nature except for conjugated linoleic acid. Furthermore, there are very few naturally produced ‘trans’ fats, but some ‘trans’ fats can be produced as a result of hydrogenation processes which occur in the rumen and during industrial processing. Examples of lipid sources which are suitable for animal feed compositions are, without limitation, palm oil, soybean oil, rapeseed/canola oil, sunflower oil, palm kernel oil, cottonseed oil, peanut oil, coconut oil, olive oil, corn oil, fish oil, poultry fat, lard and white grease. In a preferred embodiment of the feed composition of the invention the feed composition animal feed component lipid source is selected from fish oil, rapeseed oil and any combinations thereof.

The term “antioxidant” as used in herein refers to a natural substance, a processed product of a natural substance, a synthetic compound or a mixture thereof, which has an elimination, removal, or removal of free radicals within an effective amount. And/or slow down the production or increase of free radicals to slow or prevent intracellular oxidation. In one embodiment of the present invention, the radicals are reactive oxygen species (ROS) including superoxide anion (O2-), hydrogen peroxide (H2O2) and hydroxyl radical (·OH). In a preferred embodiment of the feed composition of the invention the feed composition animal feed component antioxidant is selected from a group consisting of nano-selenium, vitamin C, vitamin E, L-selenomethionine, peptides, amino acids, chitooligosaccharide derivatives, astaxanthin, carotenoids, sulphated polysaccharides, phlorotannins, phenolic compound, flavones and combinations thereof.

In the context of the present description the term “vitamin” refers to an organic molecule that is an essential micronutrient which an organism needs in small quantities for the proper functioning of its metabolism. Essential nutrients cannot be synthesized in the organism, either at all or not in sufficient quantities, and therefore must be obtained through the diet. In a preferred embodiment of the feed composition of the invention the feed composition animal feed component vitamin is selected from a group consisting of DL-alpha tocopherol acetate, sodium menadione bisulphate, retinyl acetate, DL-cholecalciferol, thiamin, riboflavin, pyridoxine, cyanocobalamin, nicotinic acid, folic acid, ascorbic acid, inositol, biotin, calcium pantothenate, choline chloride, betaine, and combinations thereof.

The term “mineral” as used herein refers to the inorganic elements in foods that animals need to develop and function normally. Those essential for animal health include calcium, phosphorus, potassium, sodium, chloride, magnesium, iron, zinc, iodine, chromium, copper, fluoride, molybdenum, manganese, and selenium. In a preferred embodiment of the feed composition of the invention the feed composition animal feed component mineral is selected from a group consisting of copper sulfate, ferric sulfate, potassium iodide, manganese oxide, sodium selenite, zinc sulfate, sodium chloride, excipient wheat middling's and any combination thereof.

The term “inorganic phosphate” or “PO₄³⁻” as used herein refers to a salt of phosphoric acid with metal ions. It consists of one central phosphorus atom surrounded by four oxygen atoms in a tetrahedral arrangement. Inorganic phosphates occur naturally in many forms and are usually combined with other elements (e.g., metals such as sodium, potassium, calcium and aluminum). Inorganic phosphates are present in all living organisms and are required to support life. Inorganic phosphate in aqueous solution exists primarily as H2PO4-or HPO42-, and is an effective buffer. In a preferred embodiment of the feed composition of the invention the feed composition animal feed component phosphate source is monocalcium phosphate. The term “monocalcium phosphate” as used herein refers to an inorganic compound with the chemical formula Ca(H2PO4) 2 (“AMCP” or “CMP-A” for anhydrous monocalcium phosphate). It is commonly found as the monohydrate (“MCP” or “MCP-M”), Ca(H2PO4)2·H2O.

In the context of the present description the term phospholipid source” refers to the sum of all phospholipid component elements that an animal obtains from a feed. The term “phospholipids” or “phosphatides” refers to a class of lipids whose molecule has a hydrophilic “head” containing a phosphate group, and two hydrophobic “tails” derived from fatty acids, joined by a glycerol molecule. The phosphate group can be modified with simple organic molecules such as choline, ethanolamine or serine. The term “phospholipids” includes, but is not limited to modified, natural, synthetic, bleached, unbleached, powdered, granular, liquid, glycero-, lyso-, polyenyl PC, PPC components, and any enriched phospholipid compounds. The term phytosterols refers to plant sterols, plant stanols and esters thereof derived from sources including but not limited to vegetable oils, and pinetree oil (known as tall oil). The term tocotrienol is meant to include alpha-, beta-, gamma-, and delta-tocotrienols. Polymethoxylated flavones are meant to include compounds derived from citrus limonoids, and citrus flavonoids. Sources of phospholipids can be, without limitation, meat (e.g. chicken liver, chicken breast, beef, and pork), eggs, dairy products, fish products (salmon, trout, tuna and mackerel), plant products (cottonseed, peanut, corn, palm, rapeseed, soybean, sunflower) amongst others. In a preferred embodiment of the feed composition of the invention the feed composition animal feed component phospholipid source is soy lecithin. As used herein the term “lecithin” refers to a phospholipid, a yellow-brown fatty substance that consists of glycerol, two fatty acids, a phosphate group, and choline. In contrast to fats, which function as fuel molecules, lecithin serves a structural role in cell membranes. It is found in all cells. In certain embodiments, the phospholipid source is soy lecithin.

The term “essential amino acid”, also termed “indispensable amino acid” is an amino acid that cannot be synthesized from scratch by the organism fast enough to supply its demand, and must therefore come from the diet. The nine amino acids animals cannot synthesize are phenylalanine, valine, threonine, tryptophan, methionine, leucine, isoleucine, lysine, and histidine. All amino acids except for glycine are stereoisomers. This means that there are mirror images of their structure. It is just like how we have left hands and right hands. These are labeled L (left-handed) and D (right-handed) to distinguish the mirror images. In a preferred embodiment of the feed composition of the invention the feed composition animal feed component is L-lysine and/or DL-Methionine.

The one or more animal feed components that comprise the feed composition of the invention comprise each a set fraction of said composition wherein the sum of all fractions totals 1 or 100%. Therefore, in a preferred embodiment of the feed composition of the invention the animal feed component comprises at least one element from the group consisting of fishmeal, poultry meal, soy protein concentrate, soybean meal, wheat, rapeseed oil, and any combination thereof, wherein each element may be present in a concentration of 8% to 16% wt %, preferably 9% wt %, 9.6% wt %, 9.8% wt %, 10% wt %, 10.15% wt %, 11% wt %, 12% wt %, 12.6% wt %, 13% wt %, 14% wt %, 15% wt % and 15.4% wt %. In another preferred embodiment of the feed composition of the invention the animal feed component comprises at least one element from the group consisting of porcine blood meal, wheat gluten, corn gluten meal, sunflower meal, fish oil, and any combination thereof, wherein each element may be present in a concentration of 3% to 8% wt %, preferably 4% wt %, 5% wt %, 6% wt %, 7% wt %, 7.5% wt %. In yet another preferred embodiment of the feed composition of the invention the animal feed component comprises at least one element from the group consisting of DL-alpha tocopherol acetate, sodium menadione bisulphate, retinyl acetate, DL-cholecalciferol, thiamin, riboflavin, pyridoxine, cyanocobalamin, nicotinic acid, folic acid, ascorbic acid, inositol, biotin, calcium pantothenate, choline chloride, betaine, copper sulfate, ferric sulfate, potassium iodide, manganese oxide, sodium selenite, zinc sulfate, sodium chloride, excipient wheat middling's, antioxidant, monocalcium phosphate, L lysine, DL Methionine, Soy lecithin, and any combination thereof, wherein each element may be present in a concentration of less than 1 wt %, preferably less than 0.9% wt %, less than 0.8% wt %, less than 0.7% wt %, less than 0.6% wt %, less than 0.5% wt %, less than 0.4% wt %, less than 0.3% wt %, less than 0.25% wt %, less than 0.2% wt %, less than 0.1% wt %, less than 0.1% wt %.

In another embodiment of the feed composition of the invention the sum of the percentages of all the components is equal to 100%.

Depending on the composition and process of manufacture animal feed compositions vary in their properties and their content of crude protein, ash, moisture, gross energy and crude fat content.

As used herein the term “crude protein” refers to a measure of how much protein is in food, based on laboratory tests studying the food's chemical composition for various nitrogen-containing materials, including true proteins and amides. In animal feeds, crude protein is calculated as mineral nitrogen multiplied by 6.25 (the assumption is that proteins of typical animal feeds contain 16% nitrogen in average). The mineral nitrogen value is obtained by the Kjeldahl method (Jiang et al., Encyclopedia of Agriculture and Food Systems, 2014) or by a method giving similar results after correction, such as the

Dumas method (Nielsen, Nielsen 2014, Food Analysis. Springer Science & Business Media. p. 143). In a preferred embodiment of the feed composition of the invention the crude protein content is of between 35% to 55% wt %, preferably between 40% to 50% wt %, more preferably about 41% wt %, about 42% wt %, about 43% wt %, about 44% wt %, about 45% wt %, about 46% wt %, about 47% wt %, about 48% wt %, about 49% wt %.

The term “crude fat” as used herein is often synonymous with “ether extract” and refers to “free” lipids that can be extracted into less polar solvents such as petroleum ether or diethyl ether. “Bound” lipids require more polar solvents for extraction. Choice of solvents is based on solvent characteristics. The crude fat content can be obtained by extracting a sample with anhydrous diethyl ether by the Soxhlet extraction (Gfrerer et al., 2004, Analytical and Bioanalytical Chemistry volume 378, pages 1861-1867) and then evaporating the solvent to dry diethyl ether. In a preferred embodiment of the feed composition of the invention the crude fat content is of between 15% to 35% wt %, preferably between 20% to 30% wt %, more preferably about 21% wt %, about 22% wt %, about 23% wt %, about 24% wt %, about 25% wt %, about 26% wt %, about 27% wt %, about 28% wt %, about 29% wt %.

As used herein, the term “crude ash” refers to the content of inorganic materials, such as minerals, in feeds. Crude ash content can be determined by determining the residue remaining after the base feed oxidizes all organic materials in a high temperature furnace at 550° C. In a preferred embodiment of the feed composition of the invention the crude ash content is of between 2 to 6 wt %, preferably between 4% to 5% wt %, more preferably about 4.1% wt %, about 4.2% wt %, about 4.3% wt %, about 4.4% wt %, about 4.5% wt %, about 4.6% wt %, about 4.7% wt %, about 4.8% wt %, about 4.9% wt %, about 5.0% wt %.

The term “moisture” as used herein refers to water or other liquid diffused in a small quantity as vapor, within a solid, or condensed on a surface. The moisture content of the feed composition can be determined by methods well known to the skilled person in the art (Thiex, N. and Richardson, C. R., 2003, J ANIM SCI, 81:3255-3266). In a preferred embodiment of the feed composition of the invention the moisture content is of between 2% to 10% wt %, preferably between 4% to 7% wt %, more preferably about 4.1% wt %, about 4.2% wt %, about 4.3% wt %, about 4.4% wt %, about 4.5% wt %, about 4.6% wt %, about 4.7% wt %, about 4.8% wt %, about 4.9% wt %, about 5.0% wt %, about 5.1% wt %, about 5.2% wt %, about 5.3% wt %, about 5.4% wt %, about 5.5% wt %.

In a preferred embodiment of the feed composition of the invention the sum of all the composition percentages is equal to 100%.

The term “gross energy” or “heat of combustion” as used herein refers to the energy released by burning a sample of the feed composition of the invention in excess oxygen in an adiabatic bomb calorimeter. The gross energy term is well known to the person skilled in the art of animal feeding. The amount of gross energy depends exclusively on the chemical composition of the feed composition even though chemical composition cannot predict the energetic transformation efficiency. Gross energy as such does not take into account any losses of energy during ingestion, digestion and metabolism of the feed composition. In a preferred embodiment of the feed composition of the invention the gross energy is of between 15 and 30 MJ/Kg, preferably between 20 to 25 MJ/Kg, more preferably about 21.0 MJ/Kg, about 21.1 MJ/Kg, about 21.2 MJ/Kg, about 21.3 MJ/Kg, about 21.4 MJ/Kg, about 21.5 MJ/Kg, about 21.6 MJ/Kg, about 21.7 MJ/Kg, about 21.8 MJ/Kg, about 21.9 MJ/Kg, about 22.0 MJ/Kg, about 22.1 MJ/Kg, about 22.2 MJ/Kg, about 22.3 MJ/Kg, about 22.4 MJ/Kg, about 22.5 MJ/Kg, about 22.6 MJ/Kg, about 22.7 MJ/Kg, about 22.8 MJ/Kg, about 22.9 MJ/Kg, about 23.0 MJ/Kg.

The feed composition of the invention can be delivered to animals is several forms and/or shapes as to better adapt to the animal needs and habits. As such, in a preferred embodiment the feed composition of the invention is in the form of fodder, extruded feed, compressed feed, pelleted feed, compound feed, pellet, crumble, emulsion, premix, cake, liquid feed, dry feed, or semi dry feed. In another preferred embodiment the feed composition of the invention is in the form of pellets, wherein the pellet has a size of 3 mm to 7 mm, preferably 4 mm, 5 mm, or 6 mm.

### Process to Obtain Unbranched Beta Glucans

Unbranched beta glucans can be obtained by a variety of ways from a variety of sources, such as previously mentioned. Depending on the source or material from where the unbranched beta glucans are derived and the method or procedure with which they are obtained, the molecular characteristics of the unbranched beta glucans can be very different.

Therefore another aspect of the invention relates to a process for obtaining the food supplement of the invention, from here onwards the first process of the invention, the process selected from the group consisting of:
(a) a first process which comprises the steps of
   (i) Providing a source of unbranched beta-glucans, wherein the unbranched beta glucan is formed by β-D-glucopyranosyl monomers connected by either β-1,3 glucosidic bonds and/or β-1,4 glucosidic bonds;
   (ii) Grounding the source of step i) obtaining a flour;
   (iii) Blending the flour obtained in step i) with a solvent;
   (iv) Stirring the mixture obtained in step (iii) at temperatures adequate for the inactivation of β-glucanases
   (v) Recovering the insoluble fraction
(b) a second process which comprises the steps of
   (i) Providing a source of unbranched beta-glucans, wherein the unbranched beta glucan is formed by β-D-glucopyranosyl monomers connected by either β-1,3 glucosidic bonds and/or β-1,4 glucosidic bonds;
   (ii) Mixing the source with boiling water
   (iii) Digesting the mixture obtained in step (ii) with an amylase
   (iv) Treating the amylase-treated mixture obtained in step (iii) with at least one protease under conditions adequate for the activity of said at least one protease and
   (v) Recovering the soluble fraction.

All the definitions and embodiments previously described in relation to other aspects apply equally to the current aspect and its embodiments of the invention.

### Process to Obtain Unbranched Beta Glucans—First Step

The first step, step (i), of both processes (a) and (b) of the process of the invention comprises “providing a source of unbranched beta-glucans, wherein the unbranched beta glucan is formed by β-D-glucopyranosyl monomers connected by either β-1,3 glucosidic bonds and/or β-1,4 glucosidic bonds”, which refers to the process of making available for use or supplying said source of unbranched beta glucans. The term “source” as used herein refers to the material which contains or provides the unbranched beta glucans for the feed composition or the process of the invention. In a preferred embodiment of the first process of the invention the source in step (i) of process (a) or process (b) is a cereal, preferably oat, more preferably oat bran.

### Process to Obtain Unbranched Beta Glucans—Second Step

Once the processes are provided with a source of unbranched beta glucans the next step of process (a)—step (ii)—comprises “grounding the source of step (i) obtaining a flour”. The grounding process can be done in a cyclone sample mill wherein the flour has a grain diameter of less than 5 millimeters (mm), less than 4 mm, less than 3 mm, less than 2 mm, preferably less than 1 mm, more preferably less than 5 mm.

Step (ii) of process (b) of the process of the invention comprises the “mixing of the source of step (i) with boiling water”. Mixing can be done by agitation, stirring, shaking, or any process which allows the source to be fully blending with the boiling water. In a preferred embodiment of step (ii) of process (b) of the first process of the invention the source is cooked for at least 1 min, at least 2 min, at least 3 min, at least 4 min, at least 5 min after being mixed with the boiling water. In another preferred embodiment of the step (ii) of process (b) of the first process of the invention the mix of source and boiling water is allowed to cool after the cooking for at least 5 min, at least 6 min, at least 7 min, at least 8 min, at least 9 min, at least 10 min, at least 11 min, at least 12 min, at least 13 min, at least 14 min, at least 15 min.

### Process to Obtain Unbranched Beta Glucans—Third Step

The expression “Blending the flour obtained in step ii) with a solvent” of step (iii) of process (a) of the process of the invention refers to the mixing of bending the flour with a “solvent”, i.e. a liquid substance capable of dissolving or dispersing other substances or compounds when in contact with these. In the present case, the compound is the flour of step (ii) of process (a). In a preferred embodiment the solvent is selected from a group consisting of: acetic acid, acetone, benzene, 1-butanol, 2-butanol, chloroform, cyclohexane, diethylene glycol, diethyl ether, ethanol, ethyl acetate, ethylene glycol, glycerin, heptane, hexamethylphosphoramide (HMPA), 1-propanol, 2-propanol, water or any combination thereof. In another preferred embodiment the solvent is ethanol, preferably ethanol 70%.

The expression “digesting the mixture obtained in step (iii) with an amylase” of step (iii) of process (b) of the process of the invention as used herein refers to the process of putting into contact the mixture with an amylase such that the amylase can process the mixture. The term “amylase” as used herein refers to a class of enzymes capable of hydrolyzing starch to shorter-chain oligosaccharides, such as maltose. The glucose moiety can then be more easily transferred from maltose to a monoglyceride or glycosylmonoglyceride than from the original starch molecule. The term amylase includes α-amylases (E.C. 3.2.1.1), G4-forming amylases (E.C. 3.2.1.60), β-amylases (E.C. 3.2.1.2) and γ-amylases (E.C. 3.2.1.3). Amylases may be of bacterial or fungal origin, or chemically modified or protein engineered mutants. Alpha amylases are mostly present in the saliva of mammals such as humans. In a preferred embodiment of the first process of the invention the amylase of step (iii) of process (b) is a salivary α-amylase, preferably a human α-amylase solution. In another preferred embodiment of the first process of the invention the human α-amylase solution comprises at least 0.1 mg/ml, 0.5 mg/ml, at least 1 mg/ml, at least 2 mg/ml, at least 3 mg/ml, at least 4 mg/ml, at least 5 mg/ml, at least 6 mg/ml, at least 7 mg/ml, at least 8 mg/ml, at least 9 mg/ml, at least 10 mg/ml α-amylase.

### Process to Obtain Unbranched Beta Glucans—Fourth Step

Once the flour is blended with a solvent in step (iii) of process (a), the next step, step (iv) comprises the “stirring the mixture obtained in step (iii) at temperatures adequate for the inactivation of β-glucanases”. The term “β-glucanases” as used herein refers to enzymes that break down beta-glucans by hydrolysis of the glucosidic bond. β-glucanases can be β-1,6-glucanases, which break down β-1,3-glucans or β-1,6-glucanases, which break down (-1,6-glucans. The expression “temperatures adequate for the inactivation of β-glucanases” as used herein refers to temperatures which do not allow the enzymes to function and therefor impede their hydrolysis of beta-glucans. In preferred embodiment of the step (iv) of process (a) of the first process of the invention is performed for between 1 h to 3 h at 75° C. to 95° C., preferably for 2 h at 85° C.

Having digested the mixture with an amylase, the next step of process (b), step (iv) is “treating the amylase-treated mixture obtained in step (iii) with at least one protease under conditions adequate for the activity of said at least one protease”, i.e., providing the mixture of step (iii) with an enzyme that hydrolyses peptide bonds (has protease activity). Proteases are also called peptidases, proteinases, peptide hydrolases, or proteolytic enzymes. Examples of the protease to be used in the present invention include proteinases such as acrosin, urokinase, pepsin, elastase, enteropeptidase, cathepsin, kallikrein, kininase 2, chymotrypsin, chymopapain, collagenase, streptokinase, subtilisin, thermolysin, trypsin, thrombin, papain, pancreatopeptidase and rennin; peptidases such as aminopeptidases, for example, arginine aminopeptidase, oxytocinase and leucine aminopeptidase; angiotensinase, angiotensin converting enzyme, insulinase, carboxypeptidase, for example, arginine carboxypeptidase, kininase 1 and thyroid peptidase, dipeptidases, for example, carnosinase and prolinase and pronases; as well as other proteases, denatured products thereof and compositions thereof. In a preferred embodiment the protease used in step (iv) of process (b) of the process of the invention is selected from a group consisting of acrosin, urokinase, pepsin, elastase, enteropeptidase, cathepsin, kallikrein, kininase 2, chymotrypsin, chymopapain, collagenase, streptokinase, subtilisin, thermolysin, trypsin, thrombin, papain, pancreatopeptidase, rennin and any combination thereof. In another preferred embodiment the protease used in step (iv) of process (b) of the process of the invention is pepsin and/or trypsin.

The expression “under conditions adequate for the activity of said at least one protease” as used herein refers to the ideal conditions for the activity of the protease, that is where the enzyme is capable of hydrolyzing peptide bonds. In a preferred embodiment step (iv) of process (b) of the first process of the invention is performed at 25 to 40° C. for 15 to 150 min at a pH of 5.5 to 6.5, preferably at 37° C. for 120 min at pH 6.

### Process to Obtain Unbranched Beta Glucans—Fifth Step

The final step (v) of both process (a) and process (b) of the process of the invention is the recovery of the fraction which contains the unbranched beta glucans. In case of process (a) the fraction which contains the unbranched beta glucans is the insoluble one, while in process (b) it is the soluble fraction which contains the unbranched beta glucans. In a preferred embodiment of step (v) of process (a) or process (b) of the first process of the invention, step (v) is performed by centrifugation. Centrifugation is well known in the art and it would be obvious to the skilled person in the art to setup the parameters adequate for the centrifugation.

Another aspect of the invention relates to a food supplement obtained with the first process of the invention.

### Process to Obtain the Feed Composition of the Invention

As previously mentioned the feed composition of the invention comprises unbranched beta glucans and at least one more animal feed component.

Another aspect of the present invention is a process for obtaining a feed composition according to the invention, from here onwards the second process of the invention, comprising:
i) Providing a source of unbranched beta-glucans and one or more animal feed components, wherein the unbranched beta glucan is formed by β-D-glucopyranosyl monomers connected by either β-1,3 glucosidic bonds and/or β-1,4 glucosidic bonds;
ii) Mixing the source of unbranched beta-glucans and the animal feed components as to obtain a mixture with a content of unbranched beta glucan of at least 0.05% wt %, thereby obtaining the feed composition.

All the definitions and embodiments previously described in relation to other aspects in this description apply equally to the current aspect and its embodiments of the invention.

### Process to Obtain the Feed Composition of the Invention—First Step

In the first step of the second process of the invention a source of unbranched beta glucans and one or more animal feed components are provided, supplied or made available as to allow the second step of the process to occur. In a preferred embodiment of the second process of the invention the source in step (i) is a cereal, preferably oat, more preferably oat bran. In another preferred embodiment of the second process of the invention the animal feed component in step (i) is selected from the group consisting of porcine blood meal, poultry meal, soy protein concentrate, wheat gluten, corn gluten meal, soy bean meal, sunflower meal, wheat meal, vitamins, minerals, antioxidant, monocalcium phosphate, L-lysine, DL-Methionine, soy lecithin, fish oil, and combinations thereof.

### Process to Obtain the Feed Composition of the Invention—Second Step

In the second step the source of unbranched beta glucans and the one or more animal feed components are mixed or blended as to obtain a mixture wherein the content of unbranched beta glucans in said mixture is of at least 0.05% wt %. In a preferred embodiment of the second process of the invention step ii) the mixture obtained has a content of unbranched beta glucans from about 0.05% wt % to about 0.2% wt %, preferably from about 0.05% wt % to 0.2% wt %, from about 0.07% wt % to 0.18% wt %, from about 0.09% wt % to 0.16% wt %, from about 0.1% wt % to 0.14% wt %, from about 0.1% wt % to 0.12% wt %, from about 0.1% wt % to 0.12% wt %.

In another preferred embodiment of the second process of the invention step ii) the mixture obtained has a content of unbranched beta-glucan from about 400 mg/Kg to about 1400 mg/Kg, preferably from about 600 mg/Kg to 1200 mg/Kg, from about 800 mg/Kg to 1000 mg/Kg.

### Process to Obtain the Feed Composition of the Invention—Further Steps

Once the mixture has been obtained in step ii) of the second process of the invention, further optional steps can be performed in order to obtained the feed composition of the invention in a particular form or shape and/or provide the feed composition with additional characteristics which may be of interest.

In a preferred embodiment of the second process of the invention the process further comprises extruding the mixture obtained in step ii). The expression “extruding the mixture” as used herein refers to the process of cooking the mixture of feed ingredients under high temperature, moisture and high pressure by means of a feed extruder within short time, whereby the high temperature is a direct result of friction (dry extrusion) or preconditioning and steam injection (wet extrusion).Extrusion is a widely used method to create animal feeds these days and the skilled person in the art would be aware of the parameters required to perform the task.

In another preferred embodiment of the second process of the invention the process further comprises the step of pelletization of the mixture obtain in step ii). The term “palletization” as used herein refers to the process of transforming the feed composition of the invention into individual pellets or small rounded structures by extruding the mixture obtained in step ii) by compacting and forcing through die openings by any mechanical process using for example a pellet mill machine.

In another preferred embodiment of the second process of the invention the process further comprises the step of drying the feed composition obtained in step ii) or after extrusion. The drying can be accomplished by several methods well known in the art, namely, without limitation, convection drying, bed drying, drum drying, freeze drying, microwave-vacuum drying, shelf drying, spray drying, infrared radiation drying, combined thermal hybrid drying, sunlight and commercial food dehydrators.

Another preferred embodiment of the second process of the invention the process further comprises the step of oil coating the feed composition obtained in step ii), after extrusion or after extrusion and drying. The term “oil coating” as used herein refers to the process of adding animal fat or plant oils to the feed composition of the invention, preferably after extrusion or extrusion and pelleting in order to coat the individual pellets of the feed composition. This process can be accomplish by several methods, which are well known to the skilled person in the art, namely and without limitation, vacuum infusion coater, spraying atomization coater and centrifugal atomization coating.

Another aspect of the present invention relates to a feed composition obtained by the second process of the invention. Said feed composition obtained by the second process of the invention is identical to the feed composition of the invention and all embodiments and definitions are equally applicable. The expression “feed composition of the invention” is meant to also include the feed composition obtained by the second process of the invention.

### Methods of the Invention

Another aspect of the present invention relates to a method for rearing animals, from here onwards the first method of the invention, which comprises feeding the animals with a feed composition of the invention or with a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

The feed composition of the invention can be used for the rearing of several animals but is especially useful for the rearing of aquaculture animals. Therefore another aspect of the present invention relates to a method for rearing aquaculture animals, which comprises feeding the aquaculture animals with a feed composition of the invention or with a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions. In a preferred embodiment, the aquaculture animal is aquaculture fish, preferably trout.

All the definitions and embodiments previously described in relation to other aspects in this description apply equally to the current aspect and its embodiments of the invention.

In the present context, the term “food supplement” should be understood in a broad sense as any ingestible food product capable of supplementing the animal's normal diet, in particular to achieve specific benefits, such as increase weight gain or improved humoral response.

In a preferred embodiment the food supplement is in the form of an extract wherein the extract comprises at least 0.4% weight by weight (w/w) of the unbranched beta glucan, such as at least 1% w/w, at least 5%, at least 10%, at least 20%, at least 23%, at least 25%, at least 28% at least 30% w/w of the unbranched beta glucan.

In a preferred embodiment the food supplement unbranched beta glucan has a weight-average molecular weight of the unbranched beta glucan is at least 800 kDa, at least 1000 kDa, at least 1200 kDa, at least 1500 kDa, at least 1600 kDa, at least 1700 kDa, at least 1800 kDa, at least 1900 kDa, at least 2000 kDa, at least 2100 kDa, at least 2200 kDa.

In another preferred embodiment the food supplement unbranched beta glucans is derived from cereals, preferably oat, more preferably oat bran. In another preferred embodiment the oat brain is enriched in unbranched beta glucans. In a preferred embodiment, the food supplement unbranched beta glucans is derived from oat brain and also comprises from 10% to 25% of insoluble fibers, from 20% to 25% of proteins, from 12% to 40% of starch, from 3% to 6% of fat, from 3 to 6% of ash. In a more preferred embodiment the food supplement unbranched beta glucans is derived from oat brain and comprises 22% beta glucans, 18% insoluble fibers, 22% of proteins, 24% of starch, 5% of fat, 4% of ashes and 5% of water. In another embodiment, the food supplement unbranched beta glucans is derived from oat brain and comprises 28% beta glucans, 22% insoluble fibers, 23% of proteins, 12% of starch, 5% of fat, 4% of ashes and 6% of water. In certain embodiments, the food supplement unbranched beta glucans is derived from oat brain and comprises 14% beta glucans, 12% insoluble fibers, 21% of proteins, 40% of starch, 5% of fat, 4% of ashes and 6% of water.

As used herein the term “feeding” refers to the process of give food to the animals. Said process can be manual, i.e. the food or supplement is manually added to the culture systems of the animals, or mechanized wherein the food or supplement is automatically added to the culture systems at preset times and with preset quantities. The skilled person in the art will be well aware of the requirements of feeding the animals. In a preferred embodiment of the first method of the invention the feeding of animals is done at least 2 times, preferably at least 3 times a day. In another preferred embodiment of the first method of the invention the feeding was done until visual satiety.

In the context of the present invention the term “aquaculture” is meant to refer to the farming of aquatic organisms including fish, and crustaceans. Farming implies some form of intervention in the rearing process to enhance production, such as regular stocking, feeding, and protection from predators.

The term “aquaculture animal” refers to any species derived from saltwater or freshwater production, including coldwater and warm water species. Exemplary aquaculture animals include fish, shellfish, crustaceans, algae, and other aquatic organisms. Further non-limiting aquaculture animals include catfish, milkfish, salmon, trout, tuna, cobia, shrimp, kahala, prawns, crayfish, crabs, lobster, Asian carp, Atlantic Salmon, Barramundi, Bighead carp, Black carp, Catla, Common Carp, Grass carp, Gourami, Milkfish, Mudfish, Silver carp, Salmonids, Tilapia. In a preferred embodiment of the first method of the invention the aquaculture animal is aquaculture fish, preferably trout.

The term “trout” as used herein refers to species of freshwater fish belonging to the genera Oncorhynchus, Salmo and Salvelinus, all of the subfamily Salmoninae of the family Salmonidae. The word trout is also used as part of the name of some non-salmonid fish such as Cynoscion nebulosus, the spotted seatrout or speckled trout. Lake trout and most other trout live in freshwater lakes and rivers exclusively, while there are others, such as the steelhead, a form of the coastal rainbow trout, that can spend two or three years at sea before returning to fresh water to spawn. Trout are an important food source for humans and wildlife, including brown bears, birds of prey such as eagles, and other animals. Trout are classified as oily fish. In a preferred embodiment of the first method of the invention the trout is selected from a group consisting of Salmo obtusirostris, Salmo trutta, S. t. morpha fario, S. t. morpha lacustris, S. t. morpha trutta, Salmo platycephalus, Salmo marmoratus, Salmo letnica, S. lumi, S. aphelios, Salmo ischchan, Oncorhynchus masou rhodurus, Oncorhynchus clarki, O. c. clarki, O. c. c. f. crescenti, O. c. Utah, O. c. humboldtensis, O. c. henshawi, O. c. seleniris, O. c. behnkei, O. c. lewisi, O. c. bouvieri, O. c. pleuriticus, O. c. stomias, O. c. virginalis, Oncorhynchus gilae, O. g. gilae, O. g. apache, Oncorhynchus mykiss, Oncorhynchus mykiss mykiss, Oncorhynchus mykiss gairdneri, Oncorhynchus mykiss irideus, Oncorhynchus mykiss irideus var. beardsleei, Oncorhynchus mykiss newberrii, Oncorhynchus mykiss aguabonita, Oncorhynchus mykiss aguabonita var. gilberti, Oncorhynchus mykiss aguabonita var. stonei, Oncorhynchus mykiss aguabonita var. whitei, Oncorhynchus mykiss Kamloops, Oncorhynchus mykiss nelson, Oncorhynchus mykiss aquilarum, Oncorhynchus mykiss stonei, Oncorhynchus chrysogaster, or any combination thereof.

Another aspect of the present invention relates to a method to increase the weight yield of an animal, to increase feed utilization by an animal, to improve humoral response in an animal and/or to increase the protective intestinal mucosa in an animal, from here onwards the second method of the invention, comprising the step of providing the animal with the feed composition of the invention or with a food supplement comprising at least 5% by weight (wt %), at least 10 wt %, preferably at least 20 wt %, more preferably at least 23 wt % of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

All the definitions and embodiments previously described in relation to other aspects in this description apply equally to the current aspect and its embodiments of the invention.

The term “animal” as used herein refers to any non-human animals to which the feed composition of the invention is a suitable aliment. Such animals include, without limitation, livestock such as cows, dogs, sheep, goats, horses, donkeys, cattle, yak, water buffalos, gaur, zebu, reindeer, camels, llamas, alpacas, pigs, rabbits, and aquaculture animals such as fish, shellfish, crustaceans, algae and mollusks. In a preferred embodiment of the second method of the invention or of the uses of the invention, the animal is not a human. In another preferred embodiment of the second method of the invention or of the uses of the invention the animal is a fish, preferably a trout. In a preferred embodiment of the second method of the invention or of the uses of the invention, the trout is selected from a group consisting of Salmo obtusirostris, Salmo trutta, S. t. morpha fario, S. t. morpha lacustris, S. t. morpha trutta, Salmo platycephalus, Salmo marmoratus, Salmo letnica, S. lumi, S. aphelios, Salmo ischchan, Oncorhynchus masou rhodurus, Oncorhynchus clarki, O. c. clarki, O. c. c. f. crescenti, O. c. Utah, O. c. humboldtensis, O. c. henshawi, O. c. seleniris, O. c. behnkei, O. c. lewisi, O. c. bouvieri, O. c. pleuriticus, O. c. stomias, O. c. virginalis, Oncorhynchus gilae, O. g. gilae, O. g. apache, Oncorhynchus mykiss, Oncorhynchus mykiss mykiss, Oncorhynchus mykiss gairdneri, Oncorhynchus mykiss irideus, Oncorhynchus mykiss irideus var. beardsleei, Oncorhynchus mykiss newberrii, Oncorhynchus mykiss aguabonita, Oncorhynchus mykiss aguabonita var. gilberti, Oncorhynchus mykiss aguabonita var. stonei, Oncorhynchus mykiss aguabonita var. whitei, Oncorhynchus mykiss Kamloops, Oncorhynchus mykiss nelson, Oncorhynchus mykiss aquilarum, Oncorhynchus mykiss stonei, Oncorhynchus chrysogaster, or any combination thereof.

The expression “weight yield of an animal” as used herein refers to the ratio of the initial weight versus the final weight of an animal, wherein the initial weight is the weight at the beginning of the process of rearing and the final weight the weight of the animal at the end of the rearing process, wherein the rearing process uses as feed the feed composition of the invention or the supplement of the invention. The “weight yield of an animal” in the context of the present invention is also meant to include the ration of the final weight of an animal reared with the feed composition of the invention or with the supplement of the invention compared with the final average weight of animals reared in similar conditions but without use of the feed composition of the invention. The expression “increase weight yield of an animal” as used herein refers to the increase or gain in the final weight of an individual animal or the final average weight of a group of animals reared with the feed composition of the invention or with the supplement of the invention in comparison to the final weight of an individual animal or the final average weight of a group of animals reared in similar conditions but without the feed composition of the invention. In a preferred embodiment of the second method of the invention the increase weight yield of an animal is of at least 1%, at least 2%, at least 4%, at least 6%, at least 8%, at least 10%, at least 12%, at least 14%, at least 15%, at least 20%, at least 30%, at least 40%, at least 50%, at least 60%, at least 70%, at least 80%, at least 90%, at least 100%.

The increase in weight yield of an animal may also be a consequence of changes in the specific growth rate (SGR). The term “specific growth rate” or “SGR” as used herein refers to the mean growth rate of an aquaculture tank population. SGR=(InWf−InWi×100)/t, wherein
InWf=the natural logarithm of the final weight;
InWi=the natural logarithm of the initial weight;
t=time (days) between InWf and InWi.

The SGR can also be calculated by dividing the Percentage body weight fed per day by the food conversion rate (FCR). In another preferred embodiment of the second method of the invention the increase in weight yield of an animal is due to an increase of at least 1%, at least 2%, at least 3%, at least 4%, at least 5%, at least 6%, at least 7%, at least 8%, at least 9%, at least 10%, at least 11%, at least 12%, at least 13%, at least 14%, at least 15% of the specific growth rate.

The expression “feed utilization by an animal” as used herein refers to the direct increase of feed requirement by an animal as it growths. Likewise, the feed utilization can also be the feed requirement increase of a population of animals in order to meet the demand of an increasing growing population. In a preferred embodiment of the second method of the invention the increase of feed utilization by an animal is of at least 1%, at least 2%, at least 4%, at least 6%, at least 8%, at least 10%, at least 12%, at least 14%, at least 15%, at least 20%, at least 30%, at least 40%, at least 50%, at least 60%, at least 70%, at least 80%, at least 90%, at least 100%.

The feed utilization by an animal is directly related to the feed conversion ratio (FCR) and the protein efficient ratio (PER). As used herein the term “feed conversion ratio” or “FCR” refers to a ratio or rate-measuring of the efficiency with which the bodies of an aquaculture species converts animal feed into the desired output. In the present context the desired output in an increase in the feed utilization. In another preferred embodiment of the second method of the invention the increase in feed utilization of an animal is due to an increase of at least 1%, at least 2%, at least 3%, at least 4%, at least 5%, at least 6%, at least 7%, at least 8%, at least 9%, at least 10%, at least 11%, at least 12%, at least 13%, at least 14%, at least 15% of the feed conversion ratio.

The term “protein efficiency ratio” or “PER” as used herein refers to the weight gain of an aquaculture animal divided by its intake of a particular food protein during the test period: PER=[gain in body mass (g)]/[Protein intake (g)]. In another preferred embodiment of the second method of the invention the increase in feed utilization of an animal is due to an increase of at least 1%, at least 2%, at least 3%, at least 4%, at least 5%, at least 6%, at least 7%, at least 8%, at least 9%, at least 10%, at least 11%, at least 12%, at least 13%, at least 14%, at least 15% of the protein efficiency ratio.

The term “humoral response” or “humoral immunity” as used herein refers to the aspect of immunity that is mediated by macromolecules found in extracellular fluids such as secreted antibodies, complement proteins, and certain antimicrobial peptides. Humoral immunity is named so because it involves substances found in the humors, or body fluids in contrast to cell-mediated immunity. Humoral immunity is also referred to as antibody-mediated immunity.

Humoral response can be divided into short-term response and long-term response. In the short-term response can be included as mechanisms of response the exocrine secretions of the body which contain a plethora of distinct soluble factors, such as lysozyme, lactoferrin, peroxidases, proline-rich proteins, histatins, etc.) that protect the body from mucosal microbial pathogens. In the long-term response the antibodies which are produced by B cells when these are activated by coming into contact with an antigen, cause the destruction of extracellular microorganisms and prevent the spread of intracellular infections.

The expression “improvement of the humoral response in an animal” as used herein refers to the modification of any of the parameters which affect the humoral response which lead to a better performance by the animal in fighting pathogen infection.

Such parameters include, without limitation, increase in the levels of one or more of the soluble factors in exocrine secretions, decrease in the activation time of B cells, increase in antibody production by B cells, increase in lifetime of antibodies, etc.

In a preferred embodiment of the second method of the invention to improve the humoral response in an animal, the humoral response is the short-term humoral response. In another preferred embodiment the humoral response is improved by increasing the levels of plasma lysozyme and/or plasma antibacterial activity.

The term “lysozyme”, also known as muramidase or N-acetylmuramide glycanhydrolase, as used herein refers to an antimicrobial enzyme produced by animals that forms part of the innate immune system. Lysozyme is a glycoside hydrolase that catalyzes the hydrolysis of 1,4-beta-linkages between N-acetylmuramic acid and N-acetyl-D-glucosamine residues in peptidoglycan, which is the major component of gram-positive bacterial cell wall, compromising the integrity of bacterial cell walls causing lysis of the bacteria. Lysozyme is abundant in secretions including tears, saliva, and mucus.

The expression “increasing the levels of plasma lysozyme” as used herein refers to the increase of active enzyme in the blood plasma of the animal. Such levels can be measured as specified in the Example section 1.5.4 of the present description. In a preferred embodiment of the second method of the invention the improve humoral response is due to an increase in the levels of lysozyme by at least 1%, at least 2%, at least 3%, at least 4%, at least 5%, at least 6%, at least 7%, at least 8%, at least 9%, at least 10%, at least 11%, at least 12%, at least 13%, at least 14%, at least 15% in comparison with a reference value.

The term “reference value” or “control value” as used herein refers to a measurement of the parameter of interest in a population control compose of similar individuals which was reared with identical parameters and conditions and to which the same test of interest was performed but which were not fed the feed composition of the invention. In the present context the parameter of interest is the level of lysozyme protein in the plasma and the test of interest is an inflammatory challenge.

In the present context “protective intestinal mucosa” refers to the blanket of protective mucus which lines the whole intestine of the animal and protects the intestine by attracting water and keeping the intestine from drying, preventing inflammation and making it more difficult for pathogens to cross the intestine blood barrier. The intestinal mucosa is composed of high-molecular-weight glycoproteins known as mucins which are produced and secreted by goblet cells which reside along the whole of the intestine.

The expression “increase in protective mucosa in an animal” as used herein refers to a higher level of said mucosa lining the intestine, wherein said increase does not provoke any adverse effect in the animal. In a preferred embodiment of the second method of the invention the increase in protective intestinal mucosa is due to an increase by at least 1%, at least 2%, at least 3%, at least 4%, at least 5%, at least 6%, at least 7%, at least 8%, at least 9%, at least 10%, at least 11%, at least 12%, at least 13%, at least 14%, at least 15% of the mucus lining the intestine in comparison with a reference value. In another preferred embodiment of the second method of the invention the increase in protective intestinal mucosa is provided to an increase of the goblet cells in the intestine by at least 1%, at least 2%, at least 3%, at least 4%, at least 5%, at least 6%, at least 7%, at least 8%, at least 9%, at least 10%, at least 11%, at least 12%, at least 13%, at least 14%, at least 15% in comparison with a reference value.

### Uses of the Invention

Another aspect of the invention relates to the feed composition of the invention or a food supplement comprising at least 5% by weight (wt %), at least 10 wt %, preferably at least 20 wt %, more preferably at least 23 wt % of an unbranched beta glucan for use in a method to improve humoral response in an animal, from here onwards the first use of the invention, wherein the food supplement unbranched beta glucan is formed by β-D-glucopyranosyl monomers connected by either β-1,3 glucosidic bonds and/or β-1,4 glucosidic bonds, and wherein the food supplement is suitable for animal feed.

All the definitions and embodiments previously described in relation to other aspects in this description apply equally to the current aspect and its embodiments of the invention.

In a preferred embodiment of the first use of the invention the humoral response is short-term humoral response.

In another preferred embodiment of the first use of the invention the humoral response is improved by increasing the levels of plasma lysozyme and/or plasma antibacterial activity.

In yet another preferred embodiment of the first use of the invention the daily dose of unbrached beta glucans is of at least 35 mg/day, preferably 40 mg/day.

In another preferred embodiment of the first use of the invention the animal is not a human.

In another preferred embodiment of the first use of the invention the animal is a fish, preferably a trout.

In another preferred embodiment of the first use of the invention the trout species is selected from a group consisting of Salmo obtusirostris, Salmo trutta, S. t. morpha fario, S. t. morpha lacustris, S. t. morpha trutta, Salmo platycephalus, Salmo marmoratus, Salmo letnica, S. lumi, S. aphelios, Salmo ischchan, Oncorhynchus masou rhodurus, Oncorhynchus clarki, O. c. clarki, O. c. c. f. crescenti, O. c. Utah, O. c. humboldtensis, O. c. henshawi, O. c. seleniris, O. c. behnkei, O. c. lewisi, O. c. bouvieri, O. c. pleuriticus, O. c. stomias, O. c. virginalis, Oncorhynchus gilae, O. g. gilae, O. g. apache, Oncorhynchus mykiss, Oncorhynchus mykiss mykiss, Oncorhynchus mykiss gairdneri, Oncorhynchus mykiss irideus, Oncorhynchus mykiss irideus var. beardsleei, Oncorhynchus mykiss newberrii, Oncorhynchus mykiss aguabonita, Oncorhynchus mykiss aguabonita var. gilberti, Oncorhynchus mykiss aguabonita var. stonei, Oncorhynchus mykiss aguabonita var. whitei, Oncorhynchus mykiss Kamloops, Oncorhynchus mykiss nelson, Oncorhynchus mykiss aquilarum, Oncorhynchus mykiss stonei, Oncorhynchus chrysogaster, or any combination thereof.

Another aspect of the invention relates to the feed composition of the invention or the food supplement of the invention of the food supplement obtained by the first process of the invention for use in a method to increase the protective intestinal mucosa in an animal, from here onwards the second use of the invention.

All the definitions and embodiments previously described in relation to other aspects in this description apply equally to the current aspect and its embodiments of the invention.

In a preferred embodiment of the second use of the invention increase the protective intestinal mucosa in an animal is provided by an increase in the goblet cells.

In order to obtain the desired improvements in the rearing of the animals being fed with the feed composition of the invention or with the supplement of the invention (increase the weight yield of an animal, increase feed utilization by an animal, improve humoral response in an animal and/or increase the protective intestinal mucosa), the dosing of said feed composition or the supplement of the invention needs to be appropriated. The dosing maybe expressed as “Daily beta-glucans intake per animal” (mg beta-glucans/day) or as a “Daily beta-glucans intake per kg of animal” (mg beta-glucans/kg animal/day).

Therefore in certain embodiments of the methods or the uses of the invention, the feed composition or supplement is provided in a daily dose (“Daily beta-glucans intake per animal”) that provide unbranched beta glucans by weight of the animal (mg beta-glucans/day) of at least 0.5 (mg beta-glucans/day), at least 1, at least 2, at least 3, at least 5, at least 6, at least 7, at least 8, at least 9, at least 10, at least 15, at least 20, at least 25, at least 30 mg beta-glucans/day.

In certain embodiments of the methods or uses of the invention, the feed composition or supplement is provided in a daily dose “Daily beta-glucans intake per kg of animal” (mg beta-glucans/kg animal/day) that provide unbranched beta glucans by weight of the animal (mg beta-glucans/kg animal/day) of at least 4 mg beta-glucans/kg animal/day, at least 5, at least 6, at least 7, at least 8, at least 9, at least 10, at least 11, at least 12, at least 13, at least 14, at least 15, at least 16, at least 18, at least 18, at least 19, at least 20, at least 25, at least 30, at least 40 mg beta-glucans/kg animal/day.

In certain embodiments, the animal is a fish.

Therefore in certain embodiments of the methods or uses of the invention, the feed composition or supplement is provided in a daily dose (“Daily beta-glucans intake per fish”) that provide unbranched beta glucans by weight of the fish (mg beta-glucans/day) of at least 0.5 (mg beta-glucans/day), at least 1, at least 2, at least 3, at least 5, at least 6, at least 7, at least 8, at least 9, at least 10, at least 15, at least 20, at least 25, at least 30 mg beta-glucans/day.

In certain embodiments of the methods or uses of the invention, the feed composition or supplement is provided in a daily dose “Daily beta-glucans intake per kg of fish” (mg beta-glucans/kg animal/day) that provide unbranched beta glucans by weight of the fish (mg beta-glucans/kg fish/day) of at least 4 mg beta-glucans/kg animal/day, at least 5, at least 6, at least 7, at least 8, at least 9, at least 10, at least 11, at least 12, at least 13, at least 14, at least 15, at least 16, at least 18, at least 18, at least 19, at least 20, at least 25, at least 30, at least 40 mg beta-glucans/kg fish/day.

As the expert in the art knows, when the animal is a fish, the food intake depends on the temperature of the water. Thus, the “Daily beta-glucans intake per fish” (mg beta-glucans/day) or as a “Daily beta-glucans intake per kg of fish” (mg beta-glucans/kg fish/day) may depend of the temperature. For example estimations for Rainbow trout can be found in Table 1 and for Atlantic salmon in Table 2.

TABLE 1

| | Fish body | | Fish body | | Fish body | |
|---|---|---|---|---|---|---|
| | weight: 10- | | weight: 100- | | weight: >800 | |
| RAINBOW TROUT | 100 g | | 800 g | | g | |
| Average fish weight, g | 50 | | 500 | | 2000 | |
| Water temperature, ° C. | 8 | 14 | 8 | 14 | 8 | 14 |
| Feed intake, % body weight | 1.01 | 1.57 | 0.75 | 1.16 | 0.37 | 0.58 |
| Daily feed intake per fish, g | 0.505 | 0.785 | 3.75 | 5.8 | 7.4 | 11.6 |
| SWEOAT Bran BG22 level | 0.546 | 0.546 | 0.546 | 0.546 | 0.546 | 0.546 |
| in feed. % | | | | | | |
| Beta-glucans content in | 22 | 22 | 22 | 22 | 22 | 22 |
| SWEOAT Bran BG22, % | | | | | | |
| Beta glucans level in feed, | 1200 | 1200 | 1200 | 1200 | 1200 | 1200 |
| mg/kg feed | | | | | | |
| Daily beta-glucans intake | 0.6 | 0.9 | 4.5 | 7.0 | 8.9 | 13.9 |
| per fish, mg/day | | | | | | |
| Daily beta-glucans intake | 12.1 | 18.8 | 9.0 | 13.9 | 4.4 | 7.0 |
| per kg of fish, mg/kg | | | | | | |
| fish/day | | | | | | |

TABLE 2

| | Fish body | | Fish body | | Fish body | |
|---|---|---|---|---|---|---|
| | weight: 10- | | weight: 100- | | weight: >800 | |
| ATLANTIC SALMON | 100 g | | 800 g | | g | |
| Average fish weight, g | 50 | | 500 | | 2000 | |
| Water temperature, ° C. | 8 | 14 | 8 | 14 | 8 | 14 |
| Feed intake, % body weight | 0.94 | 1.61 | 0.64 | 1.09 | 0.37 | 0.64 |
| Daily feed intake per fish, g | 0.47 | 0.805 | 3.2 | 5.45 | 7.4 | 12.8 |
| SWEOAT Bran BG22 level | 0.546 | 0.546 | 0.546 | 0.546 | 0.546 | 0.546 |
| in feed. % | | | | | | |
| Beta-glucans content in | 22 | 22 | 22 | 22 | 22 | 22 |
| SWEOAT Bran BG22, % | | | | | | |
| Beta glucans level in feed, | 1200 | 1200 | 1200 | 1200 | 1200 | 1200 |
| mg/kg feed | | | | | | |
| Daily beta-glucans intake | 0.6 | 1.0 | 3.8 | 6.5 | 8.9 | 15.4 |
| per fish, mg/day | | | | | | |
| Daily beta-glucans intake | 11.3 | 19.3 | 7.7 | 13.1 | 4.4 | 7.7 |
| per kg of fish, mg/kg | | | | | | |
| fish/day | | | | | | |

The term “daily dose” as used herein refers to the amount of unbranched beta glucans obtained daily by providing the animals with the feed composition of the invention or with the food supplement of the invention of the food supplement obtained by the first process of the invention.

In yet another preferred embodiment of the second use of the invention the daily dose of unbrached beta glucans is of at least 35 mg/day, preferably 40 mg/day.

In another preferred embodiment of the second use of the invention the animal is not a human.

In another preferred embodiment of the second use of the invention the animal is a fish, preferably a trout.

In another preferred embodiment of the second use of the invention the trout species is selected from a group consisting of Salmo obtusirostris, Salmo trutta, S. t. morpha fario, S. t. morpha lacustris, S. t. morpha trutta, Salmo platycephalus, Salmo marmoratus, Salmo letnica, S. lumi, S. aphelios, Salmo ischchan, Oncorhynchus masou rhodurus, Oncorhynchus clarki, O. c. clarki, O. c. c. f. crescenti, O. c. Utah, O. c. humboldtensis, O. c. henshawi, O. c. seleniris, O. c. behnkei, O. c. lewisi, O. c. bouvieri, O. c. pleuriticus, O. c. stomias, O. c. virginalis, Oncorhynchus gilae, O. g. gilae, O. g. apache, Oncorhynchus mykiss, Oncorhynchus mykiss mykiss, Oncorhynchus mykiss gardneri, Oncorhynchus mykiss irideus, Oncorhynchus mykiss irideus var. beardsleei, Oncorhynchus mykiss newberrii, Oncorhynchus mykiss aguabonita, Oncorhynchus mykiss aguabonita var. gilberti, Oncorhynchus mykiss aguabonita var. stonei, Oncorhynchus mykiss aguabonita var. whitei, Oncorhynchus mykiss Kamloops, Oncorhynchus mykiss nelson, Oncorhynchus mykiss aquilarum, Oncorhynchus mykiss stonei, Oncorhynchus chrysogaster, or any combination thereof.

The invention is described below by means of the following examples which are to be construed as merely illustrative and not limitative of the scope of the invention.

### EXAMPLES

### 1. Material & Methods

### 1.1. Test Products

The products under testing were supplied in a ready to use powder form:
Yeast cell wall beta-glucan, with 59.1% β-Glucans (Macrogard, from Biorigin, Brazil).
SWEOAT Bran BG22 product with 23.0% β-Glucans (supplied by NATUREX)

### 1.2. Experimental Diets

The trial comprised four experimental diets (Table 3). A control diet (CTRL) mimicking a commercial trout feed and three additional diets all based on the same control formulation, but supplemented with either a yeast cell wall β-glucan (Macrogard) at 0.1% (MACRO 0.1) or with SWEOAT Bran BG22 at 0.273 (SWEOAT 0.273) and 0.545% (SWEOAT 0.545). Diets MACRO 0.1 and SWEOAT 0.273 had an identical dose of 600 mg/kg of β-glucans, while diet SWEOAT 0.545 had a dose of 1200 mg/kg of β-glucans. Test products were incorporated pre-extrusion at the expenses of wheat. Feeds were supplemented with crystalline amino acids (L-lysine and DL-methionine) and an inorganic phosphorus source (monocalcium phosphate) to avoid any nutritional imbalance. All diets were isonitrogenous (44% CP), isolipidic (22% CF) and isoenergetic (22.8 MJ/kg).

TABLE 3
Formulation of experimental diets.

| Ingredients, % | CTRL | MACRO 0.1 | SWEOAT 0.273 | SWEOAT 0.545 |
|---|---|---|---|---|
| Fishmeal ¹ | 10.000 | 10.000 | 10.000 | 10.000 |
| Porcine blood meal ² | 3.000 | 3.000 | 3.000 | 3.000 |
| Poultry meal ³ | 10.000 | 10.000 | 10.000 | 10.000 |
| Soy protein concentrate ⁴ | 15.400 | 15.400 | 15.400 | 15.400 |
| Wheat gluten ⁵ | 7.500 | 7.500 | 7.500 | 7.500 |
| Corn gluten meal ⁶ | 8.000 | 8.000 | 8.000 | 8.000 |
| Soybean meal ⁷ | 10.000 | 10.000 | 10.000 | 10.000 |
| Sunflower meal ⁸ | 5.000 | 5.000 | 5.000 | 5.000 |
| Wheat ⁹ | 10.150 | 10.050 | 9.877 | 9.605 |
| Fish oil ¹⁰ | 6.000 | 6.000 | 6.000 | 6.000 |
| Rapeseed oil ¹¹ | 12.600 | 12.600 | 12.600 | 12.600 |
| Vitamin and mineral premix ¹² | 1.000 | 1.000 | 1.000 | 1.000 |
| Antioxidant ¹³ | 0.100 | 0.100 | 0.100 | 0.100 |
| Monocalcium phosphate ¹⁴ | 0.700 | 0.700 | 0.700 | 0.700 |
| L-Lysine ¹⁵ | 0.100 | 0.100 | 0.100 | 0.100 |
| DL-Methionine ¹⁶ | 0.250 | 0.250 | 0.250 | 0.250 |
| Soy lecithin ¹⁷ | 0.200 | 0.200 | 0.200 | 0.200 |
| Macrogard (Yeast beta glucans) | | 0.10 | | |
| SWEOAT Bran BG22 ¹⁸ | | | 0.273 | 0.545 |

¹ Super Prime: 66.3% CP, 11.5% CF, Pesquera Diamante, Peru;
² Porcine blood meal: 92% CP, 0.7% CF, SONAC, The Netherlands;
³ Poultry meal 65: 65% CP, 12% CF, SAVINOR UTS, Portugal;
⁴ Soycomil P: 62% CP, 0.7% CF, ADM, The Netherlands;
⁵ VITEN: 81% CP, 2.1% CF, Roquette, France;
⁶ Corn gluten meal: 58% CP, 4% CF, MPS, France;
⁷ Solvent extracted soybean meal: 43% CP, 2.7% CF, CARGILL, Spain;
⁸ Solvent extracted dehulled sunflower meal: 43% CP, 3% CF, MAZZOLENI SPA, Italy;
⁹ Wheat: 10.2% CP; 1.2% CF, MOLISUR, Spain;
¹⁰ Sopropêche, France;
¹¹ J. C. Coimbra Lda, Portugal;
¹² PREMIX Lda, Portugal: Vitamins (IU or mg/kg diet): DL-alpha tocopherol acetate, 100 mg; sodium menadione bisulphate, 25 mg; retinyl acetate, 20,000 IU; DL-cholecalciferol, 2,000 IU; thiamin, 30 mg; riboflavin, 30 mg; pyridoxine, 20 mg; cyanocobalamin, 0.1 mg; nicotinic acid, 200 mg; folic acid, 15 mg; ascorbic acid, 500 mg; inositol, 500 mg; biotin, 3 mg; calcium pantothenate, 100 mg; choline chloride, 1,000 mg, betaine, 500 mg. Minerals (g or mg/kg diet): copper sulfate, 9 mg; ferric sulfate, 6 mg; potassium iodide, 0.5 mg; manganese oxide, 9.6 mg; sodium selenite, 0.01 mg; zinc sulfate, 7.5 mg; sodium chloride, 400 mg; excipient wheat middling's;
¹³ VERDILOX PX, KEMIN EUROPE NV, Belgium;
¹⁴ MCP: 22.7% P, Premix Lda, Portugal;
¹⁵ L-Lysine HCl 99%: Ajinomoto Eurolysine SAS, France;
¹⁶ Rhodimet NP99, ADISSEO, France;
¹⁷ LECICO GmbH, Germany;

### 1.3. Manufacture of Experimental Diets

Diets were manufactured by extrusion at SPAROS facilities (Portugal). All powder ingredients were mixed accordingly to the target formulation in a double-helix mixer (model 500L, TGC Extrusion, France) and ground (below 400 μm) in a micropulverizer hammer mill (model SH1, Hosokawa-Alpine, Germany). Diets (pellet size: 5.0 mm) were manufactured with a twin-screw extruder (model BC45, Clextral, France) with a screw diameter of 55.5 mm. Extrusion conditions: feeder rate (92-94 kg/h), screw speed (255-260 rpm), water addition (320 ml/min), temperature barrel 1 (32-34° C.), temperature barrel 3 (109-111° C.). Extruded pellets were dried in a vibrating fluid bed dryer (model DR100, TGC Extrusion, France). After cooling, oils were added by vacuum coating (model PG-10VCLAB, Dinnissen, The Netherlands). Immediately after coating, diets were packed in sealed plastic buckets and shipped to the research site where they were stored at room temperature throughout the duration of the trial. Representative samples of each diet were taken for analysis.

Diets MACRO 0.1 and SWEOAT 0.273 had an identical dose of 600 mg/kg of β-glucans, while diet SWEOAT 0.545 had a dose of 1200 mg/kg of β-glucans

TABLE 4
Proximal composition of experimental diets.

| | CTRL | MACRO 0.1 | SWEOAT 0.273 | SWEOAT 0.545 |
|---|---|---|---|---|
| Moisture, % | 5.2 ± 0.4 | 4.7 ± 0.0 | 6.0 ± 0.4 | 4.7 ± 0.0 |
| Ash, % | 4.7 ± 0.1 | 4.7 ± 0.0 | 4.4 ± 0.0 | 4.7 ± 0.1 |
| Crude protein, % | 44.1 ± 0.1 | 44.0 ± 0.1 | 44.0 ± 0.1 | 44.0 ± 0.0 |
| Crude fat, % | 22.4 ± 0.1 | 22.4 ± 0.0 | 22.4 ± 0.1 | 22.3 ± 0.2 |
| Gross energy, MJ/kg | 22.8 ± 0.1 | 22.9 ± 0.0 | 22.8 ± 0.0 | 22.8 ± 0.1 |

Values are average ± standard deviation (n = 2).

### 1.4. Fish Trial

### 1.4.1. Fish

The experimental species under testing was rainbow trout (Oncorhynchus mykiss). Fish originated from a commercial fish farm (Truticultura do Paivó Lda, Castro Daire, Portugal). A stock of trout (approximately 600 fish) was transferred to the experimental facilities of UTAD (Vila Real, Portugal) by a duly authorized carrier and kept on sanitary quarantine for approximately 3 weeks. No mortality or pathological signs were observed in association to transport. During this period fish were fed a standard diet manufactured by SPAROS. Fish were fed by hand, in two daily meals, at approximately 1.5% biomass/day. At the start of the trial, fish were manually sorted by weight to constitute homogenous groups.

### 1.4.2. Growth Performance Trial

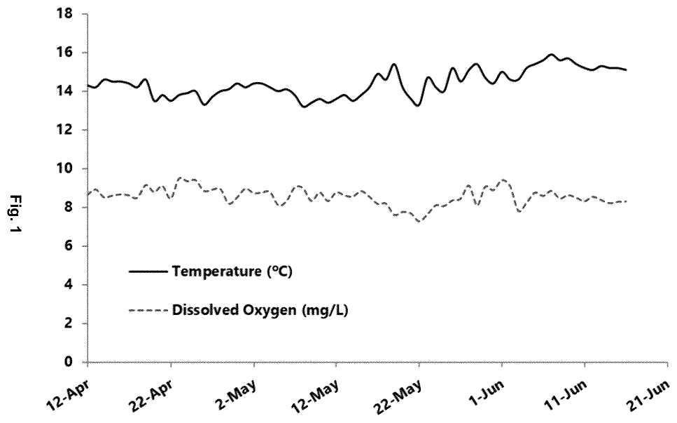

Triplicate groups of 35 trout, with a mean initial body weight (IBW) of 85.8±4.4 g were fed one of the four experimental diets during 65 days. Fish were grown in fiberglass rectangular tanks (volume: 500 L) supplied with flow-through freshwater (flow rate: 5.3 L/min; temperature 14.4±0.7° C., dissolved oxygen 8.6±0.5 mg/L; water parameters measured during the trial are presented in FIG. 1. The experimental rearing system was located outdoors and therefore fish were subjected to a natural photoperiod between mid-April and mid-June.

Fish were hand fed to visual satiety, in 3 meals per day (9:00, 14:00 and 17.00 h). Utmost care was taken to avoid feed wastage and allow a precise quantification of feed intake. Allocation of test diets to the experimental units (tanks) was made by full randomization. Experimental tanks and corresponding feed container were uniquely labelled. To follow zootechnical performance and feed utilization, light anesthetized fish (2.5 mg/L of isoeugenol, ScanAqua AS, Norway) were group weighed at day 30 and day 65.

After being subjected to a lethal anesthesia (20 mg/L of isoeugenol, ScanAqua AS, Norway), a pool of 6 whole-fish from the initial stock (start of the trial) and a pool of 6 whole-fish from each replicate tank at the end of the trial (day 65) were sampled and stored at −20° C. for subsequent analysis of whole-body composition. Additionally, the posterior intestine of 6 individual fish per dietary treatment were sampled and preserved in phosphate buffered formalin for 24 h and subsequently stored in ethanol (70%) for subsequent histological analysis. A section of the anterior intestine was snap-frozen in liquid nitrogen and stored at −80° C. for subsequent microbiome analysis.

1.4.3. Inflammatory Challenge With Inactivated bacterium (Yersinia ruckeri)

At the end of the growth performance trial, fish from each dietary treatment were subjected to an inflammatory challenge to assess their short-term humoral immune response. To characterize a basal level pre-inflammatory status (TO), 3 fish per replicate tank (9 fish per diet) were subjected to moderate anesthesia (20 ml/L of AQUI-S, New Zealand) and a sample of blood was collected by puncture of the caudal vein with a heparinized syringe. Part of the blood sample was used for determination of hematocrit, red blood cells (RBC) and white blood cells (WBC) counts, while the other part was centrifuged at 1590×g for 10 minutes. Serum (i.e., supernatant fraction) was transferred to Eppendorf tubes, snap-frozen in liquid nitrogen and stored at −80° C. until subsequent analysis of several additional humoral parameters. In addition to blood and plasma, skin mucus samples were also collected for the same 3 fish per replicate tank (9 fish per diet).

Skin mucus was collected by gentle scraping the dorso-lateral surface of fish using a cell scraper with enough care to avoid contamination with blood and urine excretions. Mucus samples were homogenized with Tris-buffered saline (50 mM Tris-HCl, pH 8.0, 150 mM NaCl). The homogenate was vigorously shaken and centrifuged at 1500 rpm for 10 min at 4 C being the supernatant lyophilized following freezing at −80° C. for subsequent analysis.

After this initial sampling, 12 fish per diet were intraperitoneally (i.p.) injected with 100 μl of UV-killed Yersinia ruckeri, according to an inflammatory model previously established (Afonson et al., 1998, Dis. Aquat. Organ., 34:27-37). Six hours (T6) post-injection, 3 fish per replicate tank (9 fish per diet) were again sampled for blood/plasma and mucus to assess the same immune criteria at a post-inflammatory state.

### 1.5. Analytical Methods

### 1.5.1. Biochemical Composition of Feeds and Whole-Fish

Analysis of diets and whole-fish were carried with analytical duplicates and following the methodology described by AOAC (2006, Official Methods of Analysis of AOAC International, 18th ed., Rev. 1, Association of Official Analytical Chemists, Washington, USA). Briefly, dry matter after drying at 105° C. for 24 h; total ash by combustion (550° C. during 6 h) in a muffle furnace (Nabertherm L9/11/B170, Germany); crude protein (N×6.25) by a flash combustion technique followed by a gas chromatographic separation and thermal conductivity detection with a Leco N Analyzer (Model FP-528, Leco Corporation, USA); crude lipid by petroleum ether extraction (40-60° C.) using a Soxtec™ 2055 Fat Extraction System (Foss, Denmark), with prior acid hydrolysis with 8.3 M HCl; gross energy in an adiabatic bomb calorimeter (Werke C2000, IKA, Germany). Beta-glucans in test products was performed with a commercial Yeast β-Glucans enzymatic kit (K-EBHLG, Megazyme, USA).

### 1.5.2. Intestinal Status

For assessing the intestinal histomorphology, sections of anterior intestine were fixed in phosphate buffered formalin for 24 h and subsequently stored in ethanol (70%) until further processing and sectioning by standard histological techniques. Sections were cut at 3 μm, mounted on glass slides, and stained with hematoxylin and eosin (HE) for histological analysis. The impact of dietary treatments was assessed by light microscopy in terms of villus height (μm, measured from the tip to the base of villus), villus width (μm) and presence of goblet cells per area of epithelium layer. Sections were also stained for neutral and acid mucins using Alcian blue (AB) and periodic acid-Schiff (PAS). Computerized morphometric measurements were made using an image analysis software (Touptek E3CMOS 3.0 DC). Images were obtained with a Nikon Eclipse e200 microscope equipped with a camera (Touptek E3CMOS 3.0 DC) and acquisition software. These analyses were performed by a specialized subcontractor ICTIOVET S.L. (Barcelona, Spain).

### 1.5.3. Hematology Profile

Hematocrit was measured by filling microcapillary tubes (10 μl) with blood and centrifuging at 12000×g for 5 min. Counting of total red (RBC) and white (WBC) blood cells was performed according to Machado et al. (2015, Fish & Shellfish Immunology 42, 353-362). The solution for the white blood cells counting resulted from a dilution 1/20 of homogenized blood in HBSS solution with heparin (30 units/ml), while RBC counting resulted from a dilution 1/200 of homogenized blood in HBSS with heparin at the same concentration mentioned above. Cell counts were performed in a Neubauer chamber. Values of WBC and RBC are presented in concentration, 10⁴/μl and 10⁶/μl, respectively.

### 1.5.4. Plasma and Mucus Immune Criteria

Lysozyme activity was assessed by a turbidimetric assay, following the methodology described by Costas et al. (2011, Fish Shellfish Immun., 31:838-84). Briefly, a solution of Micrococcus lysodeikticus (0.5 mg/ml, 0.05 M sodium phosphate buffer, pH 6.2) was prepared. Fifteen (15) μl of plasma/mucus was added to a microplate and 250 μl of the above suspension were pipetted to give a final volume of 265 μl. The reaction was carried out at 25° C. and the absorbance (450 nm) was measured after 0.5 and 4.5 min in a Synergy HT microplate reader. Serial diluted, lyophilized hen egg white lysozyme in sodium phosphate buffer (0.05 M, pH 6.2), was used to develop a standard curve. The amount of lysozyme in the sample was calculated using the formula of the standard curve.

Antiprotease activity was determined as described by Machado et al. (2015). Briefly, 10 μl of plasma/mucus were incubated with 10 μl of a trypsin solution (5 mg/ml in NaHCO₃, 5 mg/ml, pH 8.3) during 10 minutes at 22° C. in polystyrene microtubes. To the incubation mixture, 125 μl of azocasein (20 mg/ml in NaHCO₃, 5 mg/ml, pH 8.3) and 100 μl of phosphate buffer (NaH₂PO₄, 13.9 mg/ml, pH 7.0) were added and incubated at 22° C. for 1 hour. After incubation, 250 μl of trichloroacetic acid were added to each microtube and followed a 30 min incubation at 22° C. The end solution was then centrifuged at 10 000×g for 5 min at room temperature. Afterwards, 100 μl of the resulting supernatant was transferred into a 96 well microplate that previously contained a 100 μl solution of NaOH (40 mg/ml) per well. OD was read at 450 nm. Blank were prepared with phosphate buffer instead of plasma and trypsin, and the reference sample had phosphate buffer in substitution of plasma. Data are expressed as % of trypsin activity inhibition.

Plasma bactericidal activity was measured according to Machado et al. (2015). Briefly, 10 μl of plasma were added in duplicate wells in a U-shaped 96-well microplate. Positive control was prepared by adding HBSS instead of plasma to chosen wells. Each well received 20 μl of Vibrio harveyi (3.13×10⁶ CFU/ml) and then incubated for 2.5 h at 25° C. Each well was added 25 μl of 3-(4,5 dimethyl-2-yl)-2,5-diphenyl tetrazolium bromide (1 mg/ml) Sigma) and then incubated for 10 min at same temperature to allow formation of formazan. After incubation, microplates were centrifuged at 2000×g for 10 min and the precipitate was dissolved in 200 μl of dimethyl sulfoxide. Absorbance of dissolved formazan was read at 540 nm. Bactericidal activity was expressed as percentage of non-viable bacteria, calculated as the difference between absorbance of bacteria surviving compared to the absorbance of bacteria from positive controls (100%).

### 1.6. Zootechnical Evaluation Criteria

IBW (g): Initial mean body weight.

FBW (g): Final mean body weight.

Specific growth rate, SGR (%/day): (Ln FBW-Ln IBW)×100/days.

Feed conversion ratio, FCR: crude feed intake/weight gain.

Feed intake, FI (% BW/day): (crude feed intake/(IBW+FBW)/2/days)×100.

Protein efficiency ratio, PER: wet weight gain/crude protein intake.

$$Retention ( \% ) = 100 \times \frac{( FBW \times NFF ) - ( IBW \times NIF )}{Nutrient intake}$$

NFF: Nutrient content of final fish

NIF: Nutrient content of initial fish

### 1.7. Statistical Analysis

Data are presented as mean of three replicates±standard deviation. Data were subjected to a one-way analysis of variance. When appropriate, means were compared by the Student-Newman-Keuls post-hoc test. Prior to ANOVA, values expressed as percentage were subjected to arcsine square root transformation. Statistical significance was tested at 0.05 probability level. All statistical tests were performed using the IBM SPSS Statistics software (version 21, USA).

### 2. Results

### 2.1. Growth Performance

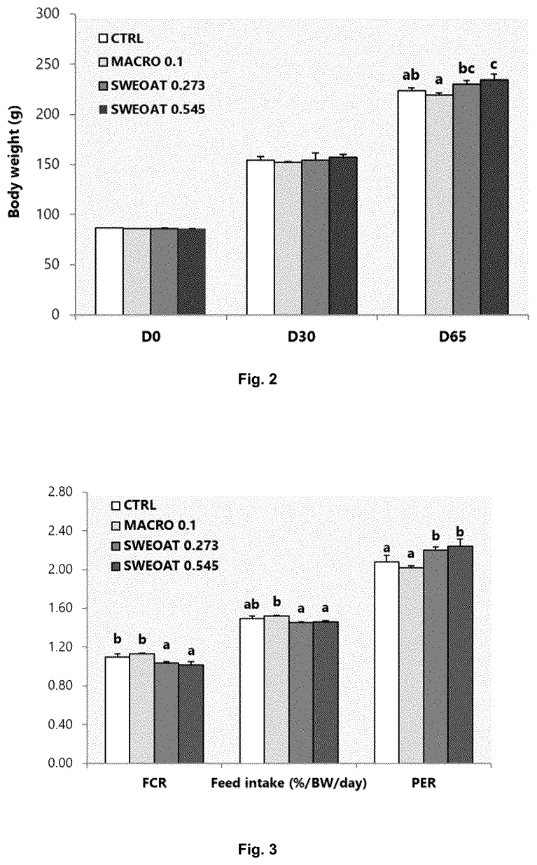

Data on overall growth zootechnical performance of trout fed for 30 and 65 days with the different experimental diets is reported in Tables 5-6 and FIGS. 2-3.

After 30 days of experimental feeding (Table 5), no mortality was observed. Final body weight (FBW) ranged between 152 and 157 g, which in the best performing treatment (SWEOAT 0.545) represented a 1.8-fold increase of the initial body weight (IBW). The specific growth rate (SGR) varied between 1.91 and 2.03%/day. Dietary treatments had no significant effect on FBW and SGR (P>0.05). The feed conversion ratio (FCR) varied between 0.97 and 1.07. Fish fed the SWEOAT 0.545 diet showed a significantly lower FCR than those fed the MACRO 0.1 diet (P<0.05). No statistical differences were found on the FCR of fish fed the CTRL, SWEOAT 0.273 and SWEOAT 0.545 diets (P>0.05). Feed intake varied between 1.87 and 2.00% average body weight per day (% ABW/d) and was not significantly affected by dietary treatments (P>0.05). The protein efficiency ratio (PER) ranged between 2.11 and 2.34. Fish fed diet SWEOAT 0.545 showed a significantly higher PER than those fed the MACRO 0.1 diet (P<0.05).

After 30 days of experimental feeding, data shows that the incorporation of SWEOAT at 0.545% improved feed utilization criteria (FCR and PER) in relation to the diet containing 0.1% of yeast beta-glucan (Macrogard), although without any significant effects on weight gain related criteria.

TABLE 5
Growth performance after 30 days of feeding.

| | CTRL | MACRO 0.1 | SWEOAT 0.273 | SWEOAT 0.545 | P value |
|---|---|---|---|---|---|
| Survival, % | 100.0 ± 0.0 | 100.0 ± 0.0 | 100.0 ± 0.0 | 100.0 ± 0.0 | — |
| IBW, g | 86.2 ± 0.2 | 85.6 ± 0.4 | 85.8 ± 0.4 | 85.4 ± 0.3 | 0.125 |
| FBW, g | 154.2 ± 3.8 | 152.0 ± 1.1 | 154.1 ± 7.1 | 157.3 ± 2.7 | 0.547 |
| SGR, %/d | 1.94 ± 0.09 | 1.91 ± 0.03 | 1.95 ± 0.16 | 2.03 ± 0.07 | 0.480 |
| FCR | 0.99 ± 0.03^{ab} | 1.07 ± 0.03^{b} | 1.00 ± 0.05^{ab} | 0.97 ± 0.02^{a} | 0.023 |
| FI, % ABW/d | 1.87 ± 0.06 | 2.00 ± 0.07 | 1.89 ± 0.06 | 1.91 ± 0.03 | 0.112 |
| PER | 2.28 ± 0.06^{ab} | 2.11 ± 0.06^{a} | 2.27 ± 0.11^{ab} | 2.34 ± 0.05^{b} | 0.024 |

Values are means ± standard deviation (n = 3). Different superscripts within a row denote a statistical difference (P < 0.05).

After 65 days of experimental feeding (end of the trial, Table 6), no mortality was observed. Final body weight (FBW) ranged between 219 and 235 g, which in the best performing treatment (SWEOAT 0.545) represented a 2.7-fold increase of the initial body weight (IBW). Fish fed the SWEOAT 0.273 and SWEOAT 0.545 diets showed a significantly higher FBW than those fed the MACRO 0.1 diet (P<0.05). Moreover, fish fed the SWEOAT 0.545 diet showed a significantly higher FBW than those fed the CTRL diet (P<0.05). The specific growth rate (SGR) varied between 1.45 and 1.55%/day. Fish fed the SWEOAT 0.273 and SWEOAT 0.545 diets showed a significantly higher SGR than those fed the CTRL and MACRO 0.1 diets (P<0.05). The feed conversion ratio (FCR) varied between 1.02 and 1.13. Fish fed the SWEOAT 0.273 and SWEOAT 0.545 diets showed a significantly lower FCR than those fed the CTRL and MACRO 0.1 diets (P<0.05). Feed intake varied between 1.45 and 1.52% average body weight per day (% ABW/d). Fish fed the SWEOAT 0.273 and SWEOAT 0.545 diets showed a significantly lower feed intake than those fed the MACRO 0.1 diet (P<0.05). The protein efficiency ratio (PER) ranged between 2.01 and 2.23. Fish fed the SWEOAT 0.273 and SWEOAT 0.545 diets showed a significantly higher PER than those fed the CTRL and MACRO 0.1 diets (P<0.05).

After 65 days of experimental feeding, data shows that the incorporation of SWEOAT at 0.273 and 0.545% improved growth (weight gain and SGR) and feed utilization criteria (FCR and PER) in relation to the diet containing 0.1% of yeast beta-glucan (Macrogard).

TABLE 6
Growth performance after 65 days of feeding.

| | CTRL | MACRO 0.1 | SWEOAT 0.273 | SWEOAT 0.545 | P value |
|---|---|---|---|---|---|
| Survival, % | 100.0 ± 0.0 | 100.0 ± 0.0 | 100.0 ± 0.0 | 100.0 ± 0.0 | — |
| IBW, g | 86.2 ± 0.2 | 85.6 ± 0.4 | 85.8 ± 0.4 | 85.4 ± 0.3 | 0.125 |
| FBW, g | 223.2 ± 3.3^{ab} | 219.1 ± 2.0^{a} | 230.1 ± 3.4^{bc} | 234.5 ± 5.3^{c} | 0.004 |
| SGR, %/d | 1.46 ± 0.02^{a} | 1.45 ± 0.02^{a} | 1.52 ± 0.01^{b} | 1.55 ± 0.04^{b} | 0.003 |
| FCR | 1.09 ± 0.03^{b} | 1.13 ± 0.01^{b} | 1.03 ± 0.01^{a} | 1.02 ± 0.03^{a} | 0.001 |
| FI, % ABW/d | 1.49 ± 0.03^{ab} | 1.52 ± 0.01^{b} | 1.45 ± 0.01^{a} | 1.46 ± 0.02^{a} | 0.006 |
| PER | 2.07 ± 0.07^{a} | 2.01 ± 0.02^{a} | 2.20 ± 0.03^{b} | 2.23 ± 0.07^{b} | 0.003 |

Values are means ± standard deviation (n = 3). Different superscripts within a row denote a statistical difference (P < 0.05).

### 2.2. Whole-Body Composition

The whole-body composition of fish at the start and end of the trial is presented in Table 7. Dietary changes had no significant effect on the whole-body composition of fish in terms of moisture, ash, protein, fat and energy (P>0.05).

TABLE 7
Whole-body composition of fish.

| | | MACRO | | | P- |
|---|---|---|---|---|---|
| | CTRL | 0.1 | SWEOAT 0.273 | SWEOAT 0.545 | value |
| Moisture, % | 67.3 ± 0.3 | 66.7 ± 0.4 | 67.4 ± 0.3 | 66.5 ± 1.3 | 0.424 |
| Ash, % | 2.0 ± 0.2 | 2.1 ± 0.2 | 2.0 ± 0.1 | 2.0 ± 0.3 | 0.951 |
| Protein, % | 16.1 ± 0.7 | 15.6 ± 0.4 | 15.5 ± 0.4 | 15.8 ± 1.1 | 0.759 |
| Fat, % | 13.3 ± 0.5 | 13.9 ± 0.5 | 13.0 ± 0.7 | 13.8 ± 0.3 | 0.148 |
| Energy, kJ/g | 8.6 ± 0.4 | 8.9 ± 0.5 | 8.5 ± 0.1 | 8.9 ± 0.3 | 0.483 |

Initial fish: moisture 73.7%, ash 2.0%, protein 14.0%, fat 7.4%, energy 6.1 kJ/g. Values are average ± standard deviation (n = 3). Values within a row with different superscripts, denote a statistical difference (P < 0.05).

### 2.3. Nutrient Retention

Whole-body nutrient retention (expressed as percentage of intake) is presented in Table 8. Dietary changes had no significant effect on the whole-body retention of protein, lipid and energy (P>0.05).

TABLE 8
Whole-body nutrient retention (% of intake).

| | CTRL | MACRO 0.1 | SWEOAT 0.273 | SWEOAT 0.545 | P-value |
|---|---|---|---|---|---|
| Protein, % | 36.3 ± 3.4 | 33.6 ± 1.4 | 36.2 ± 1.6 | 37.5 ± 3.7 | 0.404 |
| Fat, % | 69.2 ± 3.0 | 71.7 ± 3.3 | 70.6 ± 5.1 | 76.9 ± 1.0 | 0.098 |
| Energy, % | 41.0 ± 3.2 | 41.9 ± 3.6 | 42.3 ± 1.1 | 45.1 ± 1.7 | 0.321 |

Values are average ± standard deviation (n = 3). Values within a row with different superscripts, denote a statistical difference (P < 0.05).

### 1.4. Intestinal Status

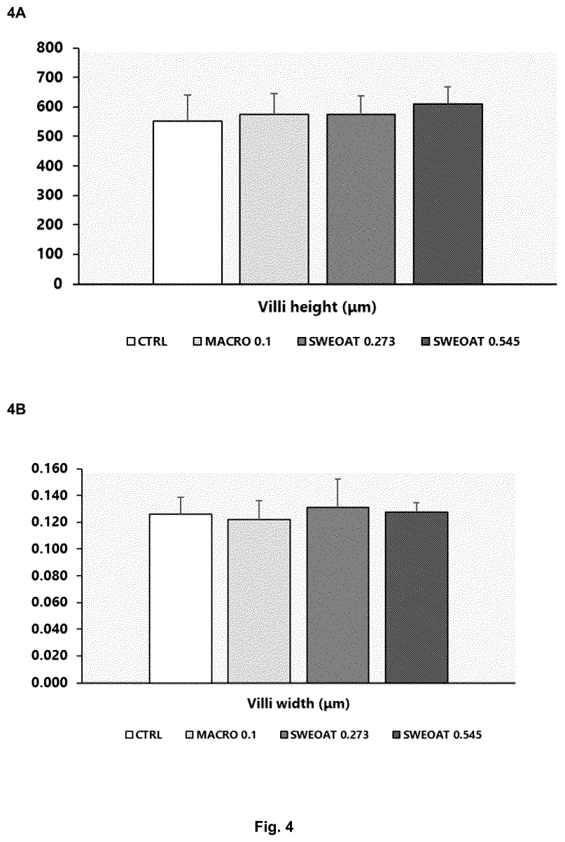

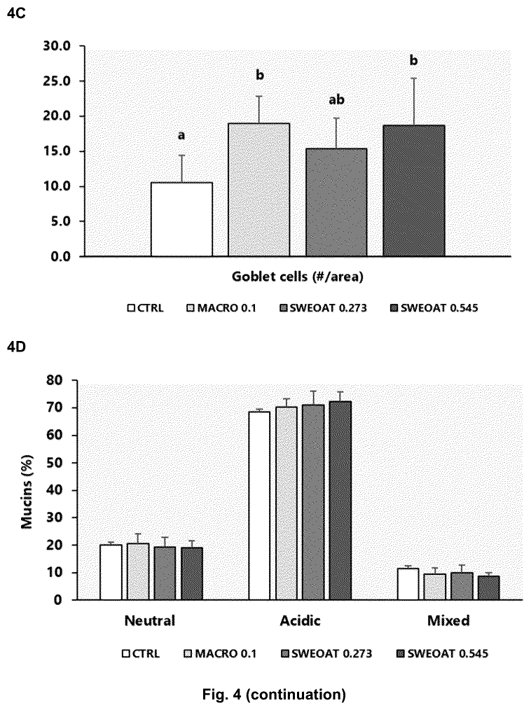

Intestinal histomorphometry of fish fed the various diets for 65 days is presented in Table 9 and FIG. 4. The height and width of intestinal villi, as well as the proportion of neutral and acidic mucins was not significantly affected by dietary treatments (P>0.05). However, fish fed the MACRO 0.1 and SWEAOT 0.545 diets showed a significant higher number of intestinal goblet cells than those fed the CTRL diet (P<0.05).

TABLE 9
Intestinal histomorphometry criteria of fish after 65 days of feeding.

| | CTRL | MACRO 0.1 | SWEOAT 0.273 | SWEOAT 0.545 | P-value |
|---|---|---|---|---|---|
| Villi, μm | | | | | |
| Height | 551.6 ± 89 | 573 ± 72 | 575 ± 62 | 609 ± 59 | 0.546 |
| Width | 0.126 ± 0.013 | 0.122 ± 0.014 | 0.131 ± 0.021 | 0.127 ± 0.007 | 0.757 |
| Goblet cells | 10.5 ± 3.9 | 19.0 ± 3.8 | 15.3 ± 4.4 | 18.7 ± 6.7 | 0.014 |
| Mucins, % | | | | | |
| Neutral | 20.1 ± 1.8 | 20.5 ± 3.7 | 19.2 ± 3.7 | 19.0 ± 2.5 | 0.867 |
| Acidic | 68.4 ± 2.7 | 70.2 ± 3.2 | 71.0 ± 5.1 | 72.3 ± 3.4 | 0.477 |
| Mixed | 11.5 ± 2.8 | 9.3 ± 2.4 | 9.8 ± 3.0 | 8.7 ± 1.2 | 0.325 |

Values are average ± standard deviation (n = 6). Values within a row with different superscripts, denote a statistical difference (P < 0.05).

### 1.5. Blood Hematology and Plasma Immune Criteria

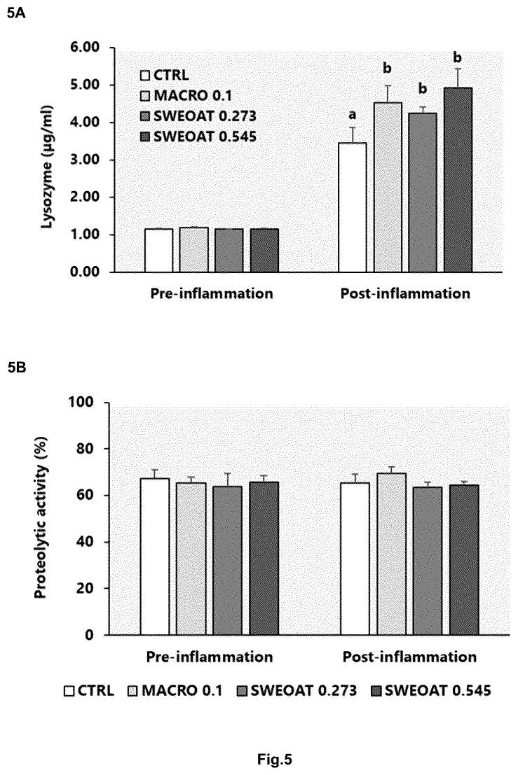

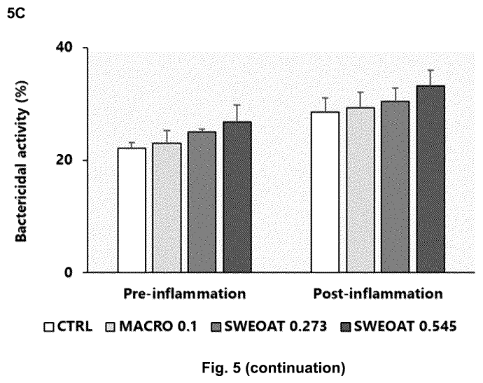

At the end of the growth performance trial, fish were subjected to an inflammatory challenge (intraperitoneal injection with UV-killed Yersinia ruckeri) to assess their short-term humoral immune response. Measurements of immune related criteria were made prior and 6 hours post-inflammation. Prior to inflammation (Table 10, FIG. 5), dietary treatments had no effect on blood hematocrit, red blood cells counts (RBC), white blood cell counts (WBC) and plasma lysozyme, antiprotease and antibacterial activity (P>0.05).

TABLE 10
Blood and plasma humoral criteria at time 0 (prior to inflammatory challenge).

| | | | SWEOAT | SWEOAT | P |
|---|---|---|---|---|---|
| | CTRL | MACRO 0.1 | 0.273 | 0.545 | value |
| Hematocrit, % | 36.6 ± 1.2 | 35.3 ± 3.3 | 35.9 ± 0.5 | 35.1 ± 2.6 | 0.851 |
| RBC, 10⁶/μL | 1.43 ± 0.02 | 1.31 ± 0.09 | 1.38 ± 0.05 | 1.44 ± 0.05 | 0.105 |
| WBC, 10⁴/μL | 2.10 ± 0.17 | 2.09 ± 0.17 | 2.17 ± 0.09 | 2.06 ± 0.05 | 0.723 |
| Lysozyme, μg/ml | 1.15 ± 0.03 | 1.19 ± 0.03 | 1.14 ± 0.01 | 1.14 ± 0.02 | 0.141 |
| Proteolytic act., % | 67.4 ± 3.8 | 65.3 ± 2.7 | 63.9 ± 5.6 | 65.6 ± 2.8 | 0.753 |
| Bactericidal act., % | 22.1 ± 1.0 | 23.0 ± 2.3 | 25.0 ± 0.5 | 26.8 ± 3.0 | 0.073 |

Values are means and standard deviation (n = 3). Different superscripts within a row represent a statistical difference (P < 0.05).

Six hours after inflammation (Table 11, FIG. 5), dietary treatments had no effect on plasma antiprotease and antibacterial activity (P>0.05). However, diets supplemented with beta-glucans (MACRO 0.1, SWEOAT 0.273 and SWEOAT 0.545) led to a significant increase of plasma lysozyme levels in comparison to the CTRL diet (P<0.05).

TABLE 11
Blood and plasma humoral criteria 6 hours after inflammatory challenge.

| | | | SWEOAT | SWEOAT | P |
|---|---|---|---|---|---|
| | CTRL | MACRO 0.1 | 0.273 | 0.545 | value |
| Lysozyme, μg/ml | 3.45 ± 0.41^{a} | 4.52 ± 0.45^{b} | 4.24 ± 0.17^{b} | 4.92 ± 0.50^{b} | 0.012 |
| Proteolytic act., % | 65.4 ± 3.7 | 69.3 ± 3.1 | 63.4 ± 2.3 | 64.4 ± 1.5 | 0.119 |
| Bactericidal act., % | 28.6 ± 2.5 | 29.3 ± 2.8 | 30.4 ± 2.4 | 33.2 ± 2.8 | 0.225 |

Values are means and standard deviation (n = 3). Different superscripts within a row represent a statistical difference (P < 0.05).

1. A method to increase the weight yield of an animal, to increase feed utilization by an animal, to improve humoral response in an animal and/or to increase the protective intestinal mucosa in an animal comprising the step of providing the animal with a) a feed composition comprising at least 0.05% wt % of unbranched beta glucan and one or more animal feed components, wherein the unbranched beta glucan is formed by β-D-glucopyranosyl monomers connected by either β-1,3 glucosidic bonds and/or β-1,4 glucosidic bonds,
or with b) a food supplement comprising at least 5% by weight (wt %) of an unbranched beta glucan, wherein the unbranched beta glucan is formed by β-D-glucopyranosyl monomers connected by either β-1,3 glucosidic bonds and/or β-1,4 glucosidic bonds, and wherein the food supplement is suitable for animal feed compositions.

2. A feed composition for use in a method to increase the weight yield of an animal, for use in a method to increase feed utilization by an animal, for use in a method to improve humoral response in an animal and/or for use in a method to increase the protective intestinal mucosa in an animal, wherein the feed composition comprises at least 0.05% wt % of unbranched beta glucan and one or more animal feed components, wherein the unbranched beta glucan is formed by β-D-glucopyranosyl monomers connected by either β-1,3 glucosidic bonds and/or β-1,4 glucosidic bonds.

3. (canceled)

4. The method according to claim 1, wherein the feed composition or the food supplement is provided daily and the daily dose of unbranched beta glucans (Daily beta-glucans intake per animal (mg beta-glucans/day)) is of at least 0.5 mg beta-glucans/day.

5. The method according to claim 1, wherein the food composition or the food supplement is provided daily and the daily dose of unbranched beta glucans (Daily beta-glucans intake per kg of animal (mg beta-glucans/kg animal/day)) is of at least 4 mg beta-glucans/kg animal/day.

6. The method according to claim 1 wherein the animal is a fish.

7. The method according to claim 6 wherein the fish is trout or salmon.

8. The method according to claim 7 wherein the trout species is selected from a group consisting of Salmo obtusirostris, Salmo trutta, S. t. morpha fario, S. t. morpha lacustris, S. t. morpha trutta, Salmo platycephalus, Salmo marmoratus, Salmo letnica, S. lumi, S. aphelios, Salmo ischchan, Oncorhynchus masou rhodurus, Oncorhynchus clarki, O. c. clarki, O. c. c. f. crescenti, O. c. Utah, O. c. humboldtensis, O. c. henshawi, O. c. seleniris, O. c. behnkei, O. c. lewisi, O. c. bouvieri, O. c. pleuriticus, O. c. stomias, O. c. virginalis, Oncorhynchus gilae, O. g. gilae, O. g. apache, Oncorhynchus mykiss, Oncorhynchus mykiss mykiss, Oncorhynchus mykiss gairdneri, Oncorhynchus mykiss irideus, Oncorhynchus mykiss irideus var. beardsleei, Oncorhynchus mykiss newberrii, Oncorhynchus mykiss aguabonita, Oncorhynchus mykiss aguabonita var. gilberti, Oncorhynchus mykiss aguabonita var. stonei, Oncorhynchus mykiss aguabonita var. whitei, Oncorhynchus mykiss Kamloops, Oncorhynchus mykiss nelson, Oncorhynchus mykiss aquilarum, Oncorhynchus mykiss stonei, Oncorhynchus chrysogaster, or any combination thereof.

9. The method according to claim 1, wherein the humoral response is short-term humoral response and/or the humoral response is improved by increasing the levels of plasma lysozyme.

10. (canceled)

11. The method according to claim 1, wherein increase of the protective intestinal mucosa in an animal is provided by an increase in the goblet cells.

12. The method according to claim 1, wherein the average molecular weight of the unbranched beta glucan is at least at least 800 kDa.

13. The method according to claim 1, wherein the unbranched beta-glucan is derived from oat bran, barley and/or rye.

14. The method according to claim 13, wherein the unbranched beta-glucan is derived from oat bran and the oat bran is enriched in unbranched beta-glucans.

15. The method according to claim 1, wherein the composition is substantially devoid of yeast-derived beta-glucans, of fungi-derived beta-glucans and/or of barley-derived beta glucans.

16. The method according to claim 1, wherein the composition is substantially devoid of beta-glucans containing β-(1-6)-linked side chains.

17. The method er the use according to claim 1, wherein the concentration of unbranched beta-glucan is between 400 mg/Kg and 1400 mg/Kg.

18. The method according to claim 1, wherein the animal feed component is selected from a group consisting of a protein source, a lipid source, a vitamin, an essential mineral, an antioxidant, an inorganic phosphate source, an essential amino acid, a source of phospholipids and any combination thereof, wherein the animal feed component comprises at least one element from the group consisting of fishmeal, poultry meal, soy protein concentrate, soybean meal, wheat, rapeseed oil, and any combination thereof present in a concentration of 8 to 16 wt %, and wherein the animal feed component comprises a) at least one element from the group consisting of porcine blood meal, wheat gluten, corn gluten meal, sunflower meal, fish oil, and any combination thereof present in a concentration of 3 to 8 wt % and/or b) at least one element from the group consisting of DL-alpha tocopherol acetate, sodium menadione bisulphate, retinyl acetate, DL-cholecalciferol, thiamin, riboflavin, pyridoxine, cyanocobalamin, nicotinic acid, folic acid, ascorbic acid, inositol, biotin, calcium pantothenate, choline chloride, betaine, copper sulfate, ferric sulfate, potassium iodide, manganese oxide, sodium selenite, zinc sulfate, sodium chloride, excipient wheat middling's, antioxidant, monocalcium phosphate, L-lysine, DL-Methionine, Soy lecithin, and any combination thereof present in a concentration of less than 1 wt %.

19. (canceled)

20. (canceled)

21. The method according to claim 1, wherein the feed composition is in the form of fodder, extruded feed, compressed feed, pelleted feed, compound feed, pellet, crumble, emulsion, premix, cake, liquid feed, dry feed, or semi dry feed.

22. A feed composition comprising at least 0.05% wt % of unbranched beta glucan and one or more animal feed components, wherein the unbranched beta glucan is formed by β-D-glucopyranosyl monomers connected by either β-1,3 glucosidic bonds and/or β-1,4 glucosidic bonds, wherein the unbranched beta-glucan is derived from oat bran.

23. The feed composition according to claim 22, wherein the average molecular weight of the unbranched beta glucan is at least at least 800 Kda.

24. The feed composition according to claim 22, wherein the composition is substantially devoid of yeast-derived beta-glucans, of fungi-derived beta-glucans and/or of barley-derived beta glucans.

25. The feed composition according to claim 22, wherein the composition is substantially devoid of beta-glucans containing β-(1-6)-linked side chains.

26. The feed composition according to claim 22, wherein the concentration of unbranched beta-glucan is between 400 mg/Kg and 1400 mg/Kg.

27. The feed composition according to claim 22, wherein the animal feed component is selected from a group consisting of a protein source, a lipid source, a vitamin, an essential mineral, an antioxidant, an inorganic phosphate source, an essential amino acid, a source of phospholipids and any combination thereof, wherein the animal feed component comprises at least one element from the group consisting of fishmeal, poultry meal, soy protein concentrate, soybean meal, wheat, rapeseed oil, and any combination thereof present in a concentration of 8 to 16 wt %, and wherein the animal feed component comprises a) at least one element from the group consisting of porcine blood meal, wheat gluten, corn gluten meal, sunflower meal, fish oil, and any combination thereof present in a concentration of 3 to 8 wt % and/or b) at least one element from the group consisting of DL-alpha tocopherol acetate, sodium menadione bisulphate, retinyl acetate, DL-cholecalciferol, thiamin, riboflavin, pyridoxine, cyanocobalamin, nicotinic acid, folic acid, ascorbic acid, inositol, biotin, calcium pantothenate, choline chloride, betaine, copper sulfate, ferric sulfate, potassium iodide, manganese oxide, sodium selenite, zinc sulfate, sodium chloride, excipient wheat middling's, antioxidant, monocalcium phosphate, L-lysine, DL-Methionine, Soy lecithin, and any combination thereof present in a concentration of less than 1 wt %.

28. (canceled)

29. (canceled)

30. The feed composition according to claim 22, wherein the feed composition is in the form of fodder, extruded feed, compressed feed, pelleted feed, compound feed, pellet, crumble, emulsion, premix, cake, liquid feed, dry feed, or semi dry feed.

31. A process for obtaining a feed composition according to claim 22 comprising:
i) Providing a source of unbranched beta-glucans and one or more animal feed components, wherein the unbranched beta glucan is formed by β-D-glucopyranosyl monomers connected by either β-1,3 glucosidic bonds and/or β-1,4 glucosidic bonds;
ii) Mixing the source of unbranched beta-glucans and the animal feed components as to obtain a mixture with a content of unbranched beta-glucan of at least 0.05 wt %, thereby obtaining the feed composition.

32. The process according to claim 31 wherein in step ii) the mixture obtained has a content of unbranched beta-glucan from about 0.05 wt % to about 0.2% wt.

33. The process according to claim 31 wherein in step ii) the mixture obtained has a content of unbranched beta-glucan from about 400 mg/Kg to about 1400 mg/Kg.

34. A feed composition obtained by the process according to claim 31.

35. A method for rearing aquaculture animals which comprises feeding the aquaculture animals with a feed composition according to claim 22 comprising at least 5% by weight (wt %) of an unbranched beta glucan, wherein the unbranched beta glucan is formed by β-D-glucopyranosyl monomers connected by either β-1,3 glucosidic bonds and/or β-1,4 glucosidic bonds and wherein the unbranched beta-glucan is derived from oat bran.
